(19) United States
(12) Patent Application Publication
(10) Pub. No.: US 2025/0111296 A1
(43) Pub. Date: Apr. 3, 2025

(54) SYSTEMS, APPARATUSES, AND METHODS FOR WORKFORCE CAPACITY PLANNING

(71) Applicant: UKG Inc., Weston, FL (US)

(72) Inventors: Ahmed Hadjar, Montréal (CA); Alixia Bouzigues, Montréal (CA); Beyime Tachefine, Montreal (CA); Eunice Lemamou, Montréal (CA); Pierre Montulet, Montréal (CA)

(21) Appl. No.: 18/478,444

(22) Filed: Sep. 29, 2023

(51) Int. Cl. G06Q 10/0631; G06Q 10/109

(52) U.S. Cl. CPC G06Q 10/06311; G06Q 10/06314; G06Q 10/06315; G06Q 10/109

(57) ABSTRACT

A method for workforce capacity planning that includes: interpreting one or more labor system input parameters; and determining, based at least in part on the one or more labor system input parameters and a labor contract planning model, a plurality of implicit concrete contract type values. The method further includes: for each of the plurality of implicit concrete contract type values, determining, based at least in part on the labor contract planning model, a number of contracts corresponding to the implicit concrete contract type value; generating, using the labor contract planning model and based at least in part on the plurality of implicit concrete contract type values and their corresponding numbers of contracts, a contract schedule that includes: a plurality of number-of-open-contracts to date pairings, and a plurality of number-of-closed-contracts to date pairings; and transmitting the contract schedule.

### BACKGROUND

Many businesses perform long-term workforce capacity planning to stabilize business operations and/or cash flows. For example, many businesses experience an increase in demand for labor and/or supplies during holiday seasons and a subsequent decrease in demand for labor and/or supplies following the holiday seasons. Other businesses may experience employment cycles where a large number of employees are scheduled to retire around the same time period, thus creating a foreseeable need to hire new employees to replace the retiring ones. Further, changing business cycles may result in a business having excess workforce capacity due to macroeconomic changes and/or trends. Traditional approaches to workforce capacity planning cover tactical/short-term periods and/or often require a high number of calculations which makes them incapable and/or impractical for performing workforce capacity planning for long time periods, e.g., a half a year or more, on short-term time intervals, e.g., daily or hourly. Additionally, many traditional approaches to long-term workforce capacity planning involve rigid models that are not easily combinable with other models and/or are not easily extendable.

### SUMMARY

The present disclosure provides for systems, methods, and non-transitory computer-readable media for workforce capacity planning, and embodiments, thereof. As explained in greater detail herein, embodiments of the current disclosure use a labor contract planning model based on implicit concrete contract types within a mixed-integer programing (and/or a mixed-integer linear programming) (MIP) problem/scenario to generate a contract schedule, also referred to herein as a contract opening/closing plan, for meeting a demand curve for a business. By using implicit concrete contract types, as opposed to the traditional approach, i.e., the “Enumeration Approach”, which enumerates various possible contracts to formulate a set covering a workforce capacity planning problem, embodiments of the current disclosure have a model with a smaller computational size than those used by the traditional Enumeration Approach.

As will be appreciated, the smaller computational size, provided by embodiments of the current disclosure, improves the performance of a computerized device used to generate a contract schedule by reducing the number of computations required to solve the MIP problem. For example, some embodiments may solve a MIP problem in less than half the number of computations used by the Enumeration Approach. As will be further appreciated, by reducing the number of calculations needed to solve a MIP problem, embodiments of the current disclosure make it practical to perform long term workforce capacity planning, e.g., projecting workforce capacity needs and solutions for time periods on the order of half a year, a year, multiple years, decades, etc., in shorter time intervals, e.g., on a weekly, daily, hourly, etc., basis. For example, embodiments of the current disclosure may be able to provide daily or hourly updates to a contract schedule that spans a year or more. Such frequent updates to a year-long contract schedule could not previously be performed due to the extensive number of computations required by the Enumeration Approach.

Further, embodiments of the current disclosure provide for a compact labor contract planning model that efficiently solves realistic and/or large workforce capacity planning problems/scenarios without impairing (or with less impairment as compared to traditional approaches) the extensibility of the compact labor contract planning model. For example, embodiments of the labor contract planning model, as disclosed herein, provide for a code architecture that integrates numerous entity types in a structured and extensible manner. Other embodiments of the current disclosure may provide for a methodology of combining opening and closing decision sets (for contracts) into valid implicit concrete contract types.

Accordingly, embodiments of the current disclosure provide for a method for workforce capacity planning. The method includes: interpreting, via a labor parameter circuit, one or more labor system input parameters; and determining, via a contract type identifier circuit and based at least in part on the one or more labor system input parameters and a labor contract planning model, a plurality of implicit concrete contract type values. The method further includes for each of the plurality of implicit concrete contract type values, determining, via the contract type identifier circuit and based at least in part on the labor contract planning model, a number of contracts corresponding to the implicit concrete contract type value; generating, via a contract scheduling circuit using the labor contract planning model and based at least in part on the plurality of implicit concrete contract type values and their corresponding numbers of contracts, a contract schedule that includes: a plurality of number-of-open-contracts to date pairings, and a plurality of number-of-closed-contracts to date pairings; and transmitting, via a schedule provisioning circuit, the contract schedule.

Further still, embodiments of the current disclosure may provide for a labor contract planning model: having a deep integration of a generalized ramp-up (and/or proficiency concepts) in each of one or more mathematical components forming part of the model; a generalized approach for handling the management of regular hours and overtime hours via one or more hours mathematical components, e.g., model components that may be in the form of mathematical expressions and are structured to manage and/or account for hours, e.g., hours of labor demand and/or supply; and/or a more accurate mathematical component for generalizing paid time off (PTO) release policies and/or accurate full-time to part-time target ratios.

Embodiments of the current disclosure further provide for a non-transitory computer-readable medium that stores instructions for workforce capacity planning. The stored instructions, when executed by at least one processor, cause the at least one processor to: interpret, via a labor parameter circuit, one or more labor system input parameters; and determine, via a contract type identifier circuit and based at least in part on the one or more labor system input parameters and a labor contract planning model, a plurality of implicit concrete contract type values. The stored instructions further cause the at least one processor to: for each of the plurality of implicit concrete contract type values, determine, based at least in part on the labor contract planning model, a number of contracts corresponding to the implicit concrete contract type value; generate, using the labor contract planning model and based at least in part on the plurality of implicit concrete contract type values and their corresponding numbers of contracts, a contract schedule that includes: a plurality of number-of-open-contracts to date pairings, and a plurality of number-of-closed-contracts to date pairings; and transmit the contract schedule.

Embodiments of the current disclosure also provide for an apparatus for workforce capacity planning. The apparatus includes: a labor parameter circuit; a contract type identifier circuit; a contract scheduling circuit; and a schedule provisioning circuit. The labor parameter circuit is structured to interpret one or more labor system input parameters. The contract type identifier circuit is structured to: determine, based at least in part on the one or more labor system input parameters and a labor contract planning model, a plurality of implicit concrete contract type values; and for each of the plurality of implicit concrete contract type values, determine, based at least in part on the labor contract planning model, a number of contracts corresponding to the implicit concrete contract type value. The contract scheduling circuit is structured to generate, using the labor contract planning model and based at least in part on the plurality of implicit concrete contract type values and their corresponding numbers of contracts, a contract schedule that includes: a plurality of number-of-open-contracts to date pairings, and a plurality of number-of-closed-contracts to date pairings. The schedule provisioning circuit is structured to transmit the contract schedule.

These and other systems, methods, objects, features, and advantages of the present disclosure will be apparent to those skilled in the art from the following detailed description of the embodiments and the drawings.

### BRIEF DESCRIPTION OF THE FIGURES

The disclosure and the following detailed description of certain embodiments thereof may be understood by reference to the following figures:

FIG. 1 depicts a system for workforce capacity planning, in accordance with embodiments of the current disclosure;

FIG. 2 depicts an apparatus for workforce capacity planning, in accordance with embodiments of the current disclosure;

FIG. 3 depicts a MIP problem/scenario, in accordance with embodiments of the current disclosure;

FIG. 4 depicts another view of a MIP problem/scenario, in accordance with embodiments of the current disclosure;

FIG. 5 depicts a graph of open and close total inequalities, in accordance with embodiments of the current disclosure;

FIG. 6 depicts an open and close chronological assignment, in accordance with embodiments of the current disclosure;

FIG. 7 depicts a feasible open and close assignment to a chronological assignment, in accordance with embodiments of the current disclosure;

FIG. 8 is a graph depicting total openings vs total closings vs headcounts, in accordance with embodiments of the current disclosure;

FIG. 9 depicts a proof of opening and closing total inequalities, in accordance with embodiments of the current disclosure; and

FIG. 10 depicts a method for workforce capacity planning, in accordance with embodiments of the current disclosure.

### DETAILED DESCRIPTION

For the purpose of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles disclosed herein as would normally occur to one skilled in the art to which this disclosure pertains.

All documents mentioned herein are hereby incorporated in their entirety by reference. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context.

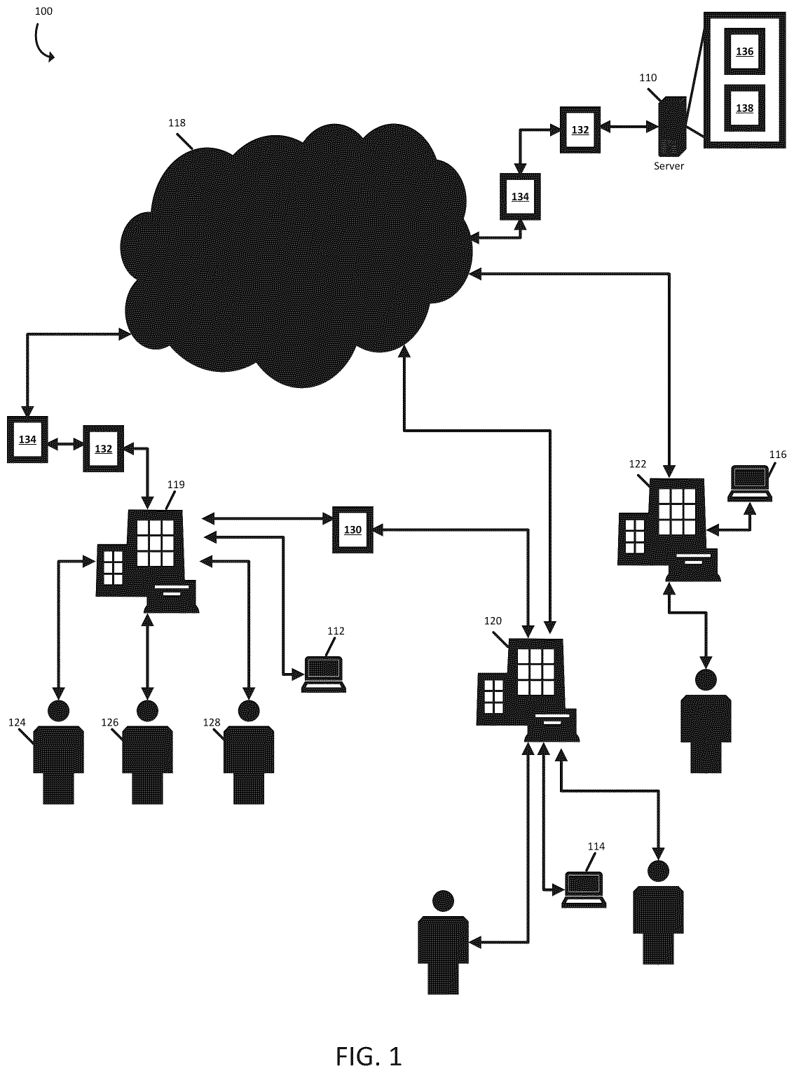

Referring to FIG. 1, a system 100 for performing workforce capacity planning, in accordance with embodiments of the current disclosure, includes one or more servers 110 in electronic communication with one or more remote client computing devices 112, 114, and/or 116 via a computer network 118, e.g., a local area network (LAN), wide area network (WAN), the Internet, etc. The one or more remote computing devices 112, 114, and/or 116 may be associated with one or more individuals and/or entities, e.g., a first corporation 119, a second corporation 120, and/or a non-corporate entity 122 such as a sole proprietorship, e.g., an individual. One or more of the entities, e.g., the first corporation 119, may require workforce capacity planning to determine whether (and/or to verify that) it will have sufficient resources, e.g., employees 124, 126, 128, and/or materials 130, to meet a projected and/or expected demand.

A remote client computing device, e.g., 112, associated with a corporation, e.g., 119, may transmit labor system input parameters 132 to the one or more servers 110 via the network 118. As described in greater detail herein, the labor system input parameters 132 may include data describing the current status of the corporation with respect to currently available and/or projected resources, e.g.: number of employees 124, 126, 128; amount of materials 130; a number of existing contracts; a number of planned contract closures; one or more future demand metrics; and/or the like. The one or more servers 110 may interpret the labor system input parameters 132 and, in response, generate a contract schedule 134. As described in greater detail herein, embodiments of the contract schedule 134 may convey a plan for opening and/or closing over a specified time period. The one or more servers 110 may then transmit the contract schedule 134 to the remote client computing device, e.g., 112. The remote client computing device, e.g., 112, may then interpret the contract schedule 134 and, in response, display the contract schedule 134 on an electronic display, verbally communicate the contract schedule 134 via a speaker, take an automated action, e.g., automatically generate a contract, automatically terminate a contract, and/or the like.

Non-limiting examples of “contracts” include an agreement (which may be legally binding) between two contracting parties for the rendering of services and/or goods, e.g., a vendor service agreement, an employment agreement, and/or the like. Non-limiting examples of contracting parties include: a business/corporation and a vendor; a business/corporation and a contract/temporary/seasonal employee; a business/corporation and an employee, etc. While the foregoing non-limiting examples concern at least one party being a business/corporation, it is to be understood that contracting parties may include non-corporate entities and/or individuals.

While “contracts” may include agreements between two contracting parties, as disclosed herein, it will be understood that “contracts” may also represent units of labor and/or materials for meeting a demand regardless of whether such contracts are associated with an agreement between two contracting parties. In other words, a contract may be a logical construct that represents labor and/or materials used to fill a slot, e.g., one or more units, of demand in a workforce capacity planning scenario/schedule where there is no actual contract being signed/executed. Thus, contracts may be associated with existing employees already under an employment agreement with a business and/or with materials already in the possession of (or obligated to be transferred to) the business.

Contracts may be “open” or “closed”. For example, an “open contract” may be a contract that has been executed and has an open term, e.g., contracts that start within the planning period/term of a contract. A “closed contract” may be a contract that has been terminated and/or has a defined termination date and/or condition triggering termination of the contract, e.g., contracts that end/terminate within the planning period/term of a contract schedule. Contracts may also be “existing” or “new”. Non-limiting examples of “existing contracts” include contracts in existence (and possibly executed) prior to the beginning of the term/planning period/time period specified in a contract schedule and may have been previously scheduled to terminate (or can be terminated optionally) during the term of the contract schedule. Existing contracts that are still running at the beginning of the term/planning period/time period specified in a contract schedule and which can be “fired”, e.g., terminated, by embodiments of the labor contract planning model may be expressed in this disclosure as a supply headcount per week and/or per type and/or as a supply hours per type. “New contracts” include contracts that are opened (and/or executed) during the term/planning period/time period specified in a contract schedule and may be scheduled to terminate during the term/planning period/time period specified in a contract schedule or may continue to remain open past the term/planning period/time period specified in a contract schedule. A “contract type” includes a label and a set of rules that any derived instance of the contract type, e.g., a contract, must respect. A “contract instance” includes a pair of specific start and end weeks along with a reference to the contract type it is derived from. The term “implicit concrete contracts” includes concrete contracts that are not defined a priori but which can be deduced from an opening and closing decision plan, e.g., a contract schedule. As will be understood, even if explicit concrete contracts are not specified in the parameters 132, their full impact on the model may be considered and their existence ensured by the open and close total inequality constraints, as will be explained in greater detail herein.

In embodiments, the one or more servers 110 may include one or more processors 136 and memory devices 138 and/or be operated by a provider of business and/or human resource tools. While FIG. 1 depicts a single server 110, it is to be understood that embodiments of the one or more servers 110 may include multiple servers located at a same site and/or distributed across multiple sites. For example, in a non-limiting example, the one or more servers 110 may provide generation of a contract schedule, e.g., 134, as a cloud services, e.g., Software as a Service (SaaS).

The entities 119, 120, and/or 122 may be a manufacturer, service provider, and/or other type of business that utilizes resources, e.g., 130, and/or labor, e.g., 128. Non-limiting examples of the entity 119 (which may be a corporation) include a retail company, e.g., clothing, electronics, home appliances, car dealerships, restaurants, food markets, etc.; a manufacturer, e.g., a furniture producer, a chemical company, a food producer, etc.; a service provider, e.g., a shipping company, a transportation company, an information technology company, a law firm, an entertainment venue, and/or the like. For example, entity 120 may be a vendor to entity 119 that supplies materials 130 used by entity 119 to manufacture goods and/or to provide services, and/or entity 122 may be a provider of contract labor to entity 119.

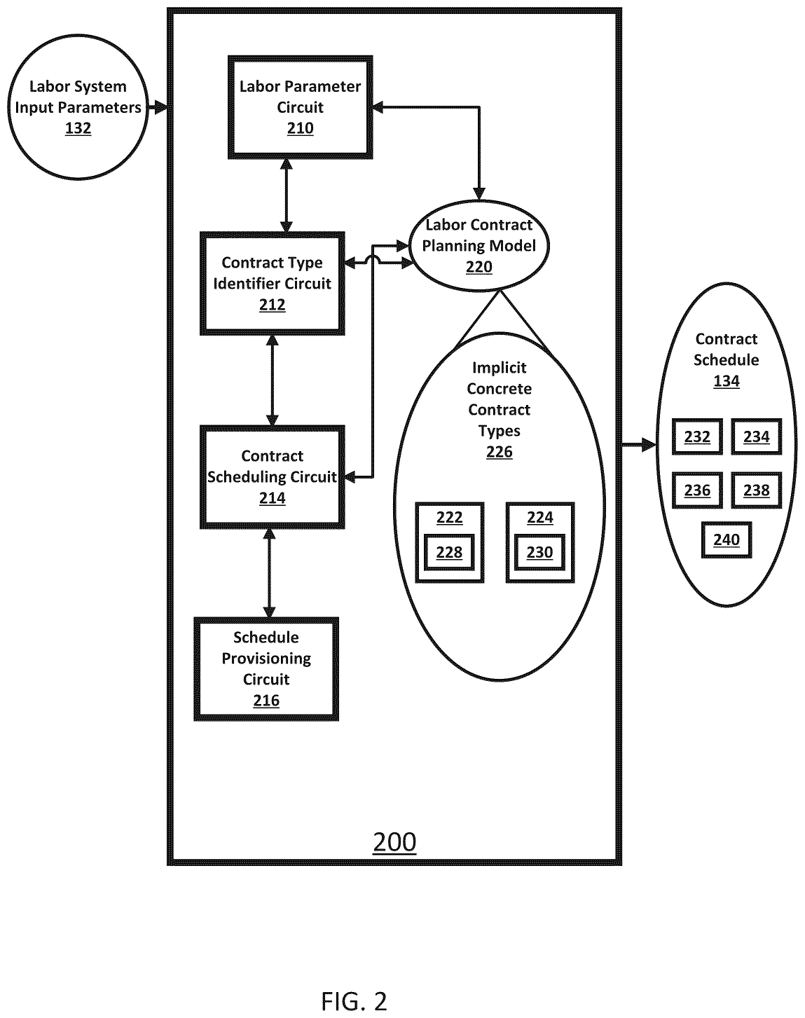

Shown in FIG. 2 is an apparatus 200 for workforce capacity planning, in accordance with embodiments of the current disclosure. The apparatus 200 may be and/or form part of the one or more servers 110 (FIG. 1), e.g., the apparatus 200 may be formed by the one or more processors 136 and/or memory device 138. The apparatus 200 may include a labor parameter circuit 210, a contract type identifier circuit 212, a contract scheduling circuit 214, and/or a schedule provisioning circuit 216. The labor parameter circuit 210 may be structured to interpret the one or more labor system input parameters 132. The contract type identifier circuit 212 may be structured to: determine, based at least in part on the one or more labor system input parameters 132 and a labor contract planning model 220, a plurality of implicit concrete contract type values 222 and 224 (collectively 226). The contract type identifier circuit 212 may be further structured to, for each of the plurality of implicit concrete contract type values 226, determine, based at least in part on the labor contract planning model 220, a number 228 and 230 of contracts corresponding to the implicit concrete contract type value. The contract scheduling circuit 214 may be structured to generate, using the labor contract planning model 220 and based at least in part on the plurality of implicit concrete contract type values 226 and their corresponding numbers, e.g., 228 and 230, of contracts, a contract schedule 134 that includes: a plurality of number-of-open-contracts to date pairings, e.g., 232 and 234, and a plurality of number-of-closed-contracts to date pairings, e.g., 236 and 238. The schedule provisioning circuit 216 may be structured to transmit the contract schedule 134. In embodiments, the contract scheduling circuit 214 may be further structured to generate a paid time off (PTO) release plan 240, based at least in part on the labor system input parameters 132, using the labor contract planning model 220. In such embodiments, the schedule provisioning circuit 216 may be further structured to transmit the PTO release plan 240, e.g., with and/or as part of the contract schedule 134, or separately from the contract schedule 134.

In embodiments, the labor contract planning model 220 may include a MIP problem/scenario. The objective of the labor contract planning model 220, and/or the MIP problem/scenario, may be to determine a contract opening/closing plan, e.g., a contract schedule 134, along with a PTO release plan 240 that can be expanded in a set of feasible contract instances with determined or undetermined ends, e.g., contracts that respect, in the planning period, or could respect, after the planning period, type minimum and maximum lengths, e.g., the maximum and minimum term lengths for contract types. The contract opening/closing plan 134 may also provide for optimal coverage for weekly demand in hours, e.g., by respecting the weekly hours ranges of the contract types. The contract opening/closing plan 134 may also respect PTO accrual and releasement logic and/or rules, e.g., by respecting the accrual relationship with the supply hours over the next month(s), by respecting an upper bound on the cumulated unreleased accrual hours (e.g., a PTO bucket having an amount of PTO accrued but not yet released at the end of a release period), and/or by respecting the logic between the bucket states between consecutive weeks, the accrual, and the releasement.

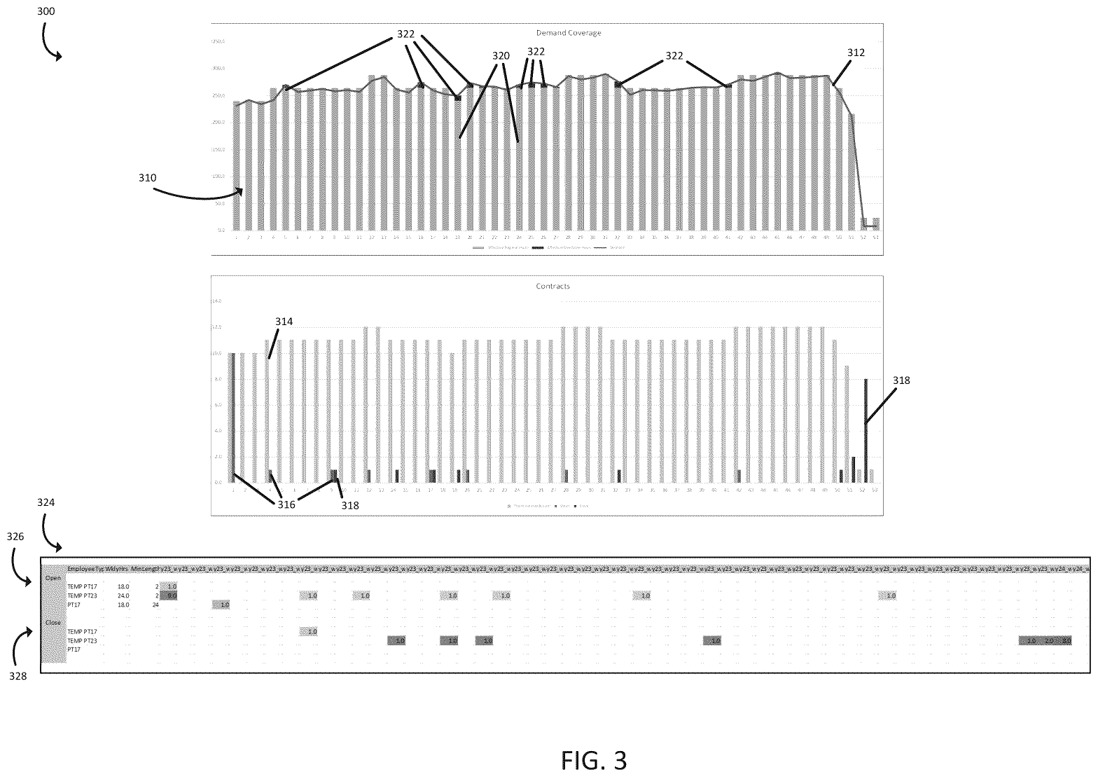

Illustrated in FIG. 3 is a non-limiting example of a MIP problem/scenario 300 where a number of contracts (represented by bars 310) is needed to cover a demand (represented by line 312). The number of contracts 310 may correspond to theorical headcount 314, open contracts 316, and/or closed contracts 318, effective regular hours 320, and/or effective overtime hours 322. The MIP problem/scenario may have a solution, e.g., a contract schedule 324 that pairs number of contracts to open 326 and/or to close 328 to times, e.g., time periods, dates, etc. In other words, the contract schedule 324 may be a plan of new contract opening and closings (of existing contract firings, e.g., contracts opened before the planning period of a contract schedule which have been scheduled for termination within the planning period) and PTO release. In embodiments, the MIP problem may be structured to prioritize (possibly in the order) the following: coverage of weekly demand; minimizing of hiring costs and payroll; and balancing of a full-time part-time ratio for a scenario where: opening and closings correspond to feasible contracts according to the allowed length range of given contract types; a contract type specifies its length range, the regular and overtime wages, the hiring costs, the proficiencies, the efficiencies, the attrition, etc.; the problem/scenario completely separates per site and skill; and that a contract cannot be closed during a ramp-up period.

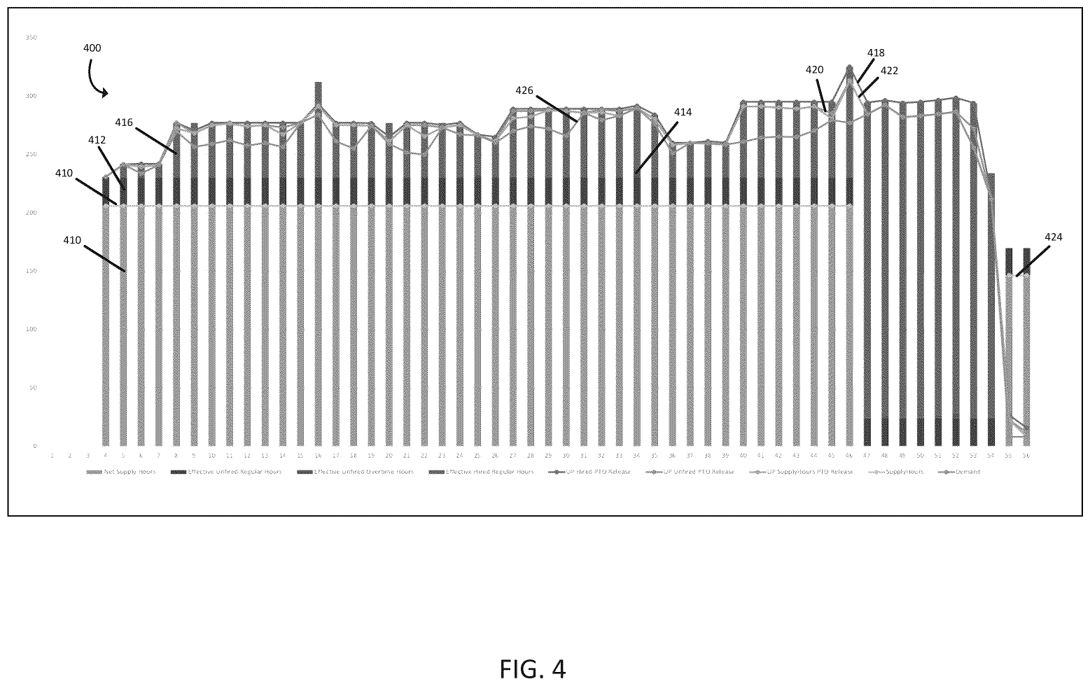

FIG. 4 depicts another view of a MIP problem/scenario 400 showing a net supply of hours 410, effective unfired regular hours 412, effective unfired overtime hours 414, effective hired regular hours 416, UP hired PTO release 418, UP unfired PTO release 420, UP, e.g., up to, supply hours PTO release 422, supply hours 424, and demand 426. In embodiments, UP refers to the cumulated curves between successive PTO releases according to the sequence (Supply Hours, Unfired Hours, Hired Hours). For example, in embodiments, Curve “UPSupplyHoursPTORelease”=“Demand”+“SupplyHoursPTORelease”; Curve “UPUnfiredPTORelease”=Curve “UPSupplyHoursPTORelease”+“UnfiredPTORelease”; Curve “HiredPTORelease”=Curve “UPUnfiredPTORelease”+“HiredPTORelease”. In such embodiments, the bars should follow the last curve as much as possible to ensure that working hours cover the demand+the total of PTORelease. As will be appreciated, the distance between two consecutive curves may correspond to the amount of the specific PTORelease.

In such a scenario, the decision types may include: opening/closing of new contracts; firing existing contracts; assigning weekly hours to new and existing contracts; releasing PTOs for new (and existing) contracts, etc. The inputs/parameters 132 (FIGS. 1 and 2) of the scenario may include demand (hours per week) for coverage; supply hours and/or supply Hcs (head counts); min/max fires; PTO policy (accrual and release); target full-time part-time ratio, and/or contract types (which may be based at least in part on length ranges, weekly hour ranges and wages, efficiencies, ramp-up, attrition etc.), and/or the like. The objective of the MIP scenario may be to minimize hiring costs, paid hours, etc.; and the constraints may include demand coverage; PTO policy; contract length rules; contract weekly hour rules; weekly min/max fired; and/or the like.

In embodiments, labor contract planning model 220 (FIG. 2) may be structured based at least on one or more assumptions. Such assumptions may include that the initial contracts overlapping the start of the planning period are not directly handled by the mathematical model. For example, the initial contracts may not be directly closed or accounted; and/or beforehand, the initial contracts may be transformed into artificial ones that can be opened only at the first week of a planning period with adjusted minimum and maximum length as well as adjusted efficiency factor(s). Such contracts may have their opening, e.g., hiring, cost set to null. While some embodiments of the current disclosure may handle initial contracts that overlap the planning period of a contract schedule through the supply Hcs/Hrs, as disclosed herein, some embodiments of the current disclosure may use an alternative method of handling such initial contracts by adding an equality constraint for those contracts for which the minimum term has been reached before the start of the planning period and an upper bound constraint for the others. Such assumptions may also include that opened contracts are not necessarily closed inside the planning period if the maximum contract length is respected; and/or that the permanent contract efficiency is always reached when the minimum contract length is reached. In other words, the efficiency may be stable form the minimum to the maximum contract length.

Embodiment of the labor contract planning model 220 may include the following main indexes: w [symbol] a week (there are typically up to one hundred weeks in the planning period); t⇔a contract type (there are typically ten contract types); and/or l⇔a proficiency level.

Embodiments of the labor contract planning model 220 may include the following parameters, which may be included in the labor system input parameters 132: W the length of the planning period in weeks; m^{t}⇔the theorical minimum size, in weeks, of a t contract independently of the planning period, also known as: “minimum contract length”; m^{t-}=m^{t}−1 is a notation used to lighten the writing of some mathematical expressions; M^{t}⇔the theorical maximum size, in weeks, of a t contract independently of the planning period, also known as: “maximum contract length” (to confirm.)”; M^{t-}=M^{t}−1 is a notation used to lighten the writing of some mathematical expressions; α^{t}⇔the efficiency of a t contract; β^{t}⇔the attrition of a t contract; η^{t}⇔the ramp-up duration in weeks of a t contract, after η^{t} weeks, (i.e., reached right after the (η^{t}−1)^{th} week) the employee is fully operational (proficient.) η^{t}≤m^{t}; δₗ^{t}, l∈[1, η^{t}]⇔the ramp-up efficiency factor of t contracts k weeks after its opening, k corresponds to the proficiency level, note that without ramp-up η^{t}=1 and δ₁^{t}=1; d_{w}⇔the hourly demand at week w; d_{w}′⇔the hard minimum head count demand at week w; ρ_{FP}⇔the target ratio FT vs PT; o_{w}^{t}⇔the number of t contracts opened at the beginning of week w, also known as: “supply hire head count”, penalized by the “hiring cost”, for a non-artificial contract, o_{w}^{t}, may be defined as ∀wϵ[1, W]; c_{w}^{t}⇔the number of t contracts closed at the ending of week w≥m^{t}, also known as: “supply fire head count”, for a non artificial contract, c_{w}^{t} is defined ∀wϵ[m^{t}, W]; y_{w}^{c}^{^{t,k}}, wϵ[k, W], k∈[1, η^{t}]⇔the theorical headcounts (e.g., ignoring the attrition rate and the efficiency factors) of t contracts with a proficiency level k at the end of week w (η^{t} is the greatest proficiency level that is reached right after the (η^{t}−1)^{th} week); x_{w}^{c}^{^{t,l}}, wϵ[1, W], l∈[1, η^{t}]⇔the actual headcounts (i.e. considering the attrition rate but ignoring the efficiency factors) of t contracts with a proficiency level l at the end of week w. (“new supply head count”.); x_{w}^{h}^{^{t,l}}, wϵ[l, W], l∈[1, η^{t}]⇔the actual hours (e.g., considering the attrition rate but ignoring the efficiency factors) of t contracts with a proficiency level l at the end of week w. (see “new supply hours”); x_{w}^{r}^{^{ht,l}}, wϵ[l, W], l∈[1, η^{t}]⇔the regular time part that is penalized using the “base rate”; x_{w}^{oh}^{^{t,l}}, w∈[l, W], l∈[1, η^{t}]⇔the overtime part that is penalized using the “additional_cost”; [symbol] _{w}^{o}^{^{t}}⇔the forward total number of t contracts opened up to the beginning of week w. [symbol] wot is defined ∀wϵ[1, W]; and/or [symbol] _{w}^{c}^{^{t}}⇔the forward total number of t contracts closed up to the end of week w (i.e., from 1 to w), [symbol] _{w}^{c}^{^{t}} is defined ∀wϵ[m^{t}, W].

### Main Constraints

Embodiments of the labor contract planning model 220 may include the following main constraints: forward vs. open/close variables; theorical headcounts vs. open/close variables; actual headcounts and hours vs. theorical headcounts; accrued, released, and PTO bucket hours vs. assigned hours; productive hours and released PTO vs. demand; full time part time ratio; and/or main terms of the objective function.

Forward vs. open/close variables

$${ℱ}^{{o}_{1}^{t}} = {o}_{1}^{t} ∀ t$$

$${ℱ}^{{o}_{w}^{t}} = {ℱ}^{{o}_{w - 1}^{t}} + {o}_{w}^{t} ∀ w ϵ [ 2 , W ] , t$$

$${ℱ}^{{c}_{{m}^{t}}^{t}} = {c}_{{m}^{t}}^{t}$$

$${ℱ}^{{c}_{w}^{t}} = {ℱ}^{{c}_{w - 1}^{t}} + {c}_{w}^{t} ∀ w ϵ [ {m}^{t} + 1 , W ] , t$$

$${ℱ}^{{o}_{w}^{t}} \geq {ℱ}^{{c}_{w + {m}^{t -}}^{t}} ∀ w ϵ [ 1 , W - {m}^{t -} ] , t$$

$${ℱ}^{{c}_{w + {M}^{t -}}^{t}} \geq {ℱ}^{{o}_{w}^{t}} ∀ w ϵ [ 1 , W - {M}^{t -} ] , t$$

As will be understood, one or more of the foregoing forward variables may be redundant since they can be substituted by their corresponding sum over the open and close variables. However, these variables may be convenient for the model clarity and/or to reduce the matrix density.

Theorical Headcounts Vs. Open/Close Variables

$${y}^{{c}_{w}^{t , l}} = {o}_{w - l + 1}^{t} ∀ w ϵ [ l , min ( {η}^{t} - 1 , W ) ] , l ∈ [ 1 , {η}^{t} - 1 ] , t$$

$${y}^{{c}_{w}^{t , {η}^{t}}} = {y}^{{c}_{w - 1}^{t , {η}^{t}}} + {o}_{w - {η}^{t} + 1}^{t} ∀ w ϵ [ {η}^{t} , {m}^{t} - 1 ] , t$$

$${y}^{{c}_{w}^{t , {η}^{t}}} = {y}^{{c}_{w - 1}^{t , {η}^{t}}} - {c}_{w - 1}^{t} + {o}_{w - {η}^{{t}_{+ 1}}}^{t} ∀ w ϵ [ {m}^{t} , W ] , t$$

Actual Headcounts and Hours Vs. Theorical Headcounts

As will be appreciated, the attrition can be applied to the theorical headcounts and first opening to get:

$${x}^{{c}_{l}^{t , l}} = {( 1 - {β}^{t} )}^{l} \cdot {o}_{1}^{t} ∀ l ∈ [ 1 , {η}^{t} ] , t$$

$${x}^{{c}_{w}^{t , l}} = ( 1 - {β}^{t} ) \cdot ( {x}^{{c}_{w - 1}^{t , l}} + ( {y}^{{c}_{w}^{t , l}} - {y}^{{c}_{w - 1}^{t , l}} ) ) ∀ w ϵ [ l + 1 , W ] , l ∈ [ 1 , {η}^{t} ] , t$$

where h^{t,l}, h^{o}^{^{t,l}}, and H^{t,l} are the weekly regular and overtime hours thresholds of t contracts with proficiency level l.

### Then:

$${x}^{{c}_{w}^{t , l}} \cdot {h}^{t , l} \leq {x}^{{rh}_{w}^{t , l}} \leq {x}^{{c}_{w}^{t , l}} \cdot {h}^{{o}^{t , l}} ∀ w ϵ [ l , W ] , l ∈ [ 1 , {η}^{t} ] , t$$

$$0 \leq {x}^{o {h}_{w}^{t , l}} \leq {x}^{{c}_{w}^{t , l}} \cdot ( {H}^{t , l} - {h}^{{o}^{t , l}} ) ∀ w ϵ [ l , W ] , l ∈ [ 1 , {η}^{t} ] , t$$

$${x}^{{h}_{w}^{t , l}} = {x}^{{rh}_{w}^{t , l}} + {x}^{o {h}_{w}^{t , l}} ∀ w ϵ [ l , W ] ,$$

As will be understood, the values α^{t}·δₖ^{t}·x_{w}^{h}^{^{t,l}} correspond to the productive hours (e.g., hours considering both the attrition rate and the efficiency factors) per proficiency levels to be considered in the demand coverage; and the values α^{t}·δₖ^{t}·x_{w}^{c}^{^{t,l}} correspond to the productive headcounts (e.g., headcounts considering both the attrition rate and the efficiency factors) per proficiency levels that can be a relevant output.

Accrued, Released, and PTO Bucket Hours Vs. Assigned Hours

In embodiments, the variables may include: a_{w}^{t}⇔the accrued PTO hours during a week w for t contracts, which may be positive only for the first week of a month (see “accrual start month”), also known as: “accrued PTO”; r_{w}^{t,l}, wϵ[l, W], l∈[1, η^{t}] the released PTO hours during week w for t contracts with a proficiency level l, also known as: “PTO release hours”; and/or b_{w}^{t}⇔the cumulated accrued and not released PTO hours (i.e the PTO to release) at the end of week w for t contracts, also known as: “PTO bucket hours to release”.

In embodiments, the parameters may be: γ^{t}⇔the minimum ratio between the released PTO hours and the supply hours at any given week for t contracts, also known as: “minimum PTO factor”, Soft Bound; Γ^{t}⇔the maximum ratio between the released PTO hours and the supply hours at any given week for t contracts, also known as: “maximum PTO factor”. Hard bound; the factor to apply to the supply hours over the weeks of a certain month to obtain the accrued PTO at a given starting month week w for t contracts (the month is set by the following parameter), also known as: “accrual factor”; [symbol] ⇔a set of week periods p=[ωₚ^{s}, ωₚ^{e}] overlapping and partionning the planning period at the start ωₚ^{s} of which the total accrued pto, over which, is associated to (given by “accrual starting month” and another control parameter.); [symbol] ={w′:∃p∈ [symbol] :w′=ωₚs}; and/or [symbol] ⇔a set of weeks at which there should be no PTO to release (given by “accrual starting month” and another control parameter):

$${a}_{{ω}_{p}^{s}}^{t} = {ϱ}^{t} \cdot {\sum }_{{w}^{′} ∈ p , l \leq {w}^{′}} {x}^{{h}_{{w}^{′}}^{t , l}} ∀ p ϵ {Ω}^{𝒜} , t$$

$${γ}^{t} \cdot {x}^{{h}_{w}^{t , l}} \begin{matrix}\leq \\ ( soft )\end{matrix} {r}_{w}^{t , l} \begin{matrix}\leq \\ ( hard )\end{matrix} {Γ}^{t} \cdot {x}^{{h}_{w}^{t , l}} ∀ w ϵ [ l + 1 , W ] , l ∈ [ 1 , {η}^{t} ] , t$$

$${b}_{1}^{t} = {a}_{1}^{t} - {r}_{1}^{t , 1} if 1 ∈ {Ω}^{𝒜 , s}$$

$${b}_{1}^{t} = 0 if 1 ∉ {Ω}^{𝒜 , s}$$

$${b}_{w}^{t} = {b}_{w - 1}^{t} + {a}_{w}^{t} - {\sum }_{l \leq w} {r}_{w}^{t , l} ∀ w ϵ [ 2 , W ] ⋂ {Ω}^{𝒜 , s} , t$$

$${b}_{w}^{t} = {b}_{w - 1}^{t} - {\sum }_{l \leq w} {r}_{w}^{t , l} ∀ w ϵ [ 2 , W ] ∖ {Ω}^{𝒜 , s} , t$$

$${\sum }_{t} {b}_{ω}^{t} \begin{matrix}Dominant soft \\ =\end{matrix} 0 ∀ ω ∈ {Ω}^{ℛ}$$

$${b}_{ω}^{t} \leq M . {\sum }_{l} {x}^{{c}_{w}^{t , l}} ∀ w ϵ [ 1 , W ] , t$$

$${b}_{ω}^{t , l} \leq M \cdot {x}^{{c}_{w}^{t , l}} ∀ w ϵ [ l + 1 , W ] , t , l$$

Note that a_{w}^{t} and b_{w}^{t} variables may be redundant.
Productive Hours and Released PTO Vs. Demand

Effective coverage hours per week w and t contracts

$${\sum }_{t , l \leq w} {α}^{t} \cdot {δ}_{l}^{t} \cdot {x}^{{h}_{w}^{t , l}} \begin{matrix}= \\ ( soft )\end{matrix} {d}_{w} + {\sum }_{t , l \leq w} {α}^{t} \cdot {δ}_{l}^{t} \cdot {r}_{w}^{t , l} ∀ w ϵ [ 1 , W ]$$

$${\sum }_{t , l \leq w} {α}^{t} \cdot {δ}_{l}^{t} \cdot {x}^{{h}_{w}^{t , l}} \geq {d}_{w}^{′} + {\sum }_{t , l \leq w} {α}^{t} \cdot {δ}_{l}^{t} \cdot {r}_{w}^{t , l} ∀ w ϵ [ 1 , W ]$$

Note that without the second constraint, the «softness» of the first constraint concerns normally the over-coverage but not the under-coverage.

### Full Time Part Time Ratio

In embodiments, φ_{w}⇔the overage of the full time part time ratio at week w; —ϕ_{w}⇔the underage of the full time part time ratio at week w; and ρ_{FP}⇔the target of the full time part time ratio.

$${\sum }_{t ↔ FT , l \leq w} ( {x}^{{h}_{w}^{t , l}} ) - {ρ}_{FP} {\sum }_{t ↔ PT , l \leq w} ( {x}^{{h}_{w}^{t , l}} - {r}_{w}^{t , l} ) = {φ}_{w} - {ϕ}_{w} ∀ w ϵ [ 1 , W ]$$

Note that −r_{w}^{t,l} corresponds to a parametrized variant for the ratio computation based on the net hours, net of the PTO releases.

### Main Terms of the Objective Function

The main independent terms of the objective function may be: the o_{w}^{t} times the corresponding “hiring cost”; the x_{w}^{rh}^{^{t,l}}, times the corresponding “base rate”; the x_{w}^{oh}^{^{t,l}} times the corresponding “additional cost”; the φ_{w} and ϕ_{w} times an unspecified rate; and the slacks related to the soft released PTO constraints. Note that the demand overcoverage minimisation can be also directly considered but may be redundant with the wage costs minimization. Further note that the paid training hours can be simply included in the “hiring cost”. For example, if new a hire needs x hours of training to be fully trained (e.g., with a α_{F}^{t} efficiency), then the “hiring cost” can be incremented by x times the “base rate”. This adjustment often makes the objective function more accurate.

### Supplied Headcounts and Hours

Embodiments of the labor contract planning model 220 may account for and/or otherwise incorporate supplied headcounts and hours. For example embodiments of the labor contract planning model 220 may be structured to use the following parameters: S_{w}^{tl}, l∈[1, η^{t}], tϵ [symbol] ⇔the supply actual headcount of type t at week w (nb the supply actual can be obtained from a supply theorical in a preprocessing); S_{w} the supply effective hours at week w; S_{w}^{FT}⇔the supply effective hours of full times at week w; m_{w}^{t}⇔the minimal number of cumulated firings of supplied t contracts from the beginning of the planning period up to the end of week w; and M_{w}^{t}⇔the maximal number of cumulated firings of supplied t contracts from the beginning of the planning period up to the end of week w. In such embodiments, the labor contract planning model 220 may be further structured to use the following variables [symbol] _{w}^{F}^{^{t}}⇔the cumulated firings of supplied t contracts from the beginning of the planning period up to the start of week w; F_{w}^{t}⇔the number of firings of the supplied t contracts at the start of week w; Y_{w}^{t}⇔the theorical fired headcounts of the supplied t contracts at the start of week w; Z_{w}^{t}⇔the actual fired headcounts of the supplied t contracts at the start of week w; X_{w}^{r}^{^{tl}}, l∈[1, η^{t}], tϵ [symbol] ⇔the regular time assigned to the unfired supply headcounts; and/or X_{w}^{o}^{^{tl}}, l∈[1, η^{t}], tϵ [symbol] the overtime assigned to the unfired supply headcounts.

Actual Headcount and Hours Vs. Theorical Fired

In embodiments, the actual headcount and hours vs. the theorical fired, e.g., contracts opened prior to the start of the planning period and continue into the planning period, may be modeled by the following:

$$ℱ {{F}_{1}^{t}}^{} = {F}_{1}^{t} ∀ t$$

$${ℱ}^{{F}_{w}^{t}} = {ℱ}^{{F}_{w - 1}^{t}} + {F}_{w}^{t} ∀ w ϵ [ 2 , W ] , t$$

$${m}_{w}^{t} \leq {ℱ}^{{F}_{w}^{t}} \leq {M}_{w}^{Lt} ∀ w ϵ [ 1 , W ] , t$$

$${Y}_{1}^{{t}_{=}} {F}_{1}^{t} ∀ t$$

$${Y}_{w}^{t} = {Y}_{w - 1}^{t} + {F}_{w}^{t} ∀ w ϵ [ 2 , W ] , t$$

$${Z}_{1}^{t} = ( 1 - {β}^{t} ) \cdot {F}_{1}^{t} ∀ t$$

$${Z}_{w}^{t} = ( 1 - {β}^{t} ) \cdot ( {Z}_{w - 1}^{t} + {F}_{w}^{c} ) ∀ w ϵ [ 2 , W ] , t$$

$${Z}_{w}^{t} \leq {S}_{w}^{t {η}^{t}} ∀ w ϵ [ 1 , W ] , t ϵ 𝒯$$

$${h}^{t} \cdot ( {S}_{w}^{t {η}^{t}} - {Z}_{w}^{t} ) \leq {X}^{{r}_{w}^{t {η}^{t}}} \leq {h}^{{o}^{t}} \cdot ( {S}_{w}^{t {η}^{t}} - {Z}_{w}^{t} ) ∀ w ϵ [ 1 , W ] , t ϵ 𝒯$$

$${h}^{t} \cdot {S}_{w}^{tl} \leq {X}_{w}^{{r}^{t , l}} \leq {h}^{{o}^{t}} \cdot {S}_{w}^{tl} ∀ w ϵ [ 1 , W ] , l ∈ [ 1 , {η}^{t} - 1 ] , t ϵ 𝒯$$

$${X}^{{o}_{w}^{t {η}^{t}}} \leq ( {H}^{t} - {h}^{{o}^{t}} ) \cdot ( {S}_{w}^{t {η}^{t}} - {Z}_{w}^{t} ) ∀ w ϵ [ 1 , W ] , t ϵ 𝒯$$

$${X}^{{o}_{w}^{tl}} \leq ( {H}^{t} - {h}^{{o}^{t}} ) \cdot {S}_{w}^{tl} ∀ w ϵ [ 1 , W ] , l ∈ [ 1 , {η}^{t} - 1 ] , t ϵ 𝒯$$

$${\sum }_{t ∉ 𝒯} {α}^{t} \cdot {h}^{t} \cdot {Z}_{w}^{t} \leq {S}_{w} ∀ w ϵ [ 1 , W ]$$

As will be appreciated, extensions may be structured to handle supply headcounts and open fire constraints per proficiency levels. This feature can provide for the consideration of fully precise carry-overs, e.g., initial contracts with their reached proficiency levels.

Accrued, Released, and PTO Bucket Hours Vs. Fired

In embodiments, the Accrued, released, and PTO bucket hours vs. fired, e.g., closed contracts, may be modeled by the as follows:

Parameters: Å_{w}⇔the supply PTO accrued hours at week w; B₀^{t}, t∈ [symbol] ⇔the cumulated accrued and not released PTO hours at the start of the planning period for t contracts, related to supply headcounts; γ⇔the minimum ratio between the released PTO hours and the supply hours at any given week for t contracts, also known as: “minimum PTO factor”, Soft Bound, Related to supply hours; and/or Γ⇔the maximum ratio between the released PTO hours and the supply hours at any given week for t contracts, also known as: “maximum PTO factor”, Soft bound, Related to supply hours.

Variables: A_{w}^{t}, t∈ [symbol] ⇔the accrued PTO hours during a week w for t contracts after firings. Positive only for starting month weeks (see “accrual starting month”); A_{w}⇔the accrued PTO hours during a week w after firings (based on Å_{w}); R_{w}^{t}, t∈ [symbol] ⇔the released PTO hours during week w for t contracts after firings; R_{w}⇔the released PTO hours during week w after firings; B_{w}^{t}, t∈ [symbol] ⇔the cumulated accrued and not released PTO hours (i.e., the PTO to release) at the end of week w for t contracts after firings; and/or B_{w}⇔the cumulated accrued and not released PTO hours (i.e., the PTO to release) at the end of week w after firings.

### Expressions:

$${A}_{{ω}_{p}^{s}}^{t} = {ϱ}^{t} \cdot {\sum }_{{w}^{′} ∈ p} {\sum }_{l ∈ [ 1 , {η}^{t} ]} ( {X}^{{r}_{w}^{t , l}} + {X}^{{o}_{w}^{t , l}} ) ∀ p {ϵΩ}^{𝒜} , t$$

$${A}_{{ω}_{p}^{s}} = {Å}_{w} - {\sum }_{t ∉ 𝒯} ( {ϱ}^{t} \cdot {\sum }_{{w}^{′} ∈ p} {α}^{t} \cdot {h}^{t} \cdot {Z}_{w}^{t} ) ∀ p {ϵΩ}^{𝒜}$$

$${γ}^{t} . {\sum }_{l ∈ [ 1 , {η}^{t} ]} ( {X}^{{r}_{w}^{t , l}} + {X}^{{o}_{w}^{t , l}} ) \begin{matrix}\leq \\ ( soft )\end{matrix} {R}_{w}^{t} \begin{matrix}\leq \\ ( hard )\end{matrix} {Γ}^{t} . {\sum }_{l ∈ [ 1 , {η}^{t} ]} ( {X}^{{r}_{w}^{t , l}} + {X}^{{o}_{w}^{t , l}} ) ∀ w ϵ [ 1 , W ] ,$$

$$0 \leq {R}_{w}^{t} \leq {\sum }_{l ∈ [ 1 , {η}^{t} ]} ( {X}^{{r}_{w}^{t , l}} + {X}^{{o}_{w}^{t , l}} ) ∀ w ϵ [ 1 , W ] , t ∈ 𝒯$$

$$γ . ( {S}_{w} - {\sum }_{t ∉ 𝒯} {α}^{t} \cdot {h}^{t} \cdot {Z}_{w}^{t} ) \begin{matrix}\leq \\ ( soft )\end{matrix} {R}_{w} \begin{matrix}\leq \\ ( hard )\end{matrix} Γ \cdot ( {S}_{w} - {\sum }_{t ∉ 𝒯} {α}^{t} \cdot {h}^{t} \cdot {Z}_{w}^{t} ) ∀ w ϵ [ 1 , W ]$$

$${B}_{1}^{t} = {B}_{0}^{t} + {A}_{1}^{t} - {R}_{1}^{t} ∀ t ∈ 𝒯$$

$${B}_{w}^{t} = {B}_{w - 1}^{t} + {A}_{w}^{t} - {R}_{w}^{t} ∀ w ϵ [ 2 , W ] , t ∈ 𝒯$$

$${B}_{1} = {A}_{1} - {R}_{1}$$

$${B}_{w} = {B}_{w - 1} + {A}_{w} - {R}_{w} ∀ w ϵ [ 2 , W ]$$

$${\sum }_{t} {b}_{w}^{t} + {\sum }_{t ∉ 𝒯} {B}_{w}^{t} + {B}_{w} = 0 ∀ w ∈ {Ω}^{ℛ}$$

### Headcounts Bounds

In embodiments, headcount bounds may be modeled as follows:

Parameters: λ, λ̅⇔the lower and upper bound of the actual headcounts.

### Expressions:

$${\sum }_{l \leq {η}^{t} , t} {x}^{{c}_{w}^{t , l}} + {\sum }_{l \leq {η}^{t} , t ∈ 𝒯} {S}_{w}^{tl} - {\sum }_{t ∈ 𝒯} {Z}_{w}^{t} \geq \underline{λ} ∀ w ϵ [ 1 , W ]$$

$${\sum }_{l \leq {η}^{t} , t} {x}^{{c}_{w}^{t , l}} + {\sum }_{l \leq {η}^{t} , t ∈ 𝒯} {S}_{w}^{tl} - {\sum }_{t ∈ 𝒯} {Z}_{w}^{t} \begin{matrix}\leq \\ ( Dominant )\end{matrix} \overline{λ} ∀ w ϵ [ 1 , W ]$$

Update of Productive Hours and Released PTO Vs. Demand

In embodiments, the updating of productive hours and released PTO vs. demand may be modeled as follows:

$${\sum }_{t , l \leq w} {α}^{t} \cdot {δ}_{l}^{t} \cdot {x}^{{h}_{w}^{t , l}} + {\sum }_{t ∈ 𝒯} {α}^{t} . {\sum }_{l ∈ [ 1 , {η}^{t} ]} ( {X}^{{r}_{w}^{t , l}} + {X}^{{o}_{w}^{t , l}} ) + ( {S}_{w} - {\sum }_{t ∈ 𝒯} {α}^{t} \cdot {h}^{t} \cdot {Z}_{w}^{t} ) \geq {d}_{w}^{′} + {\sum }_{t} {r}_{w}^{t} + {\sum }_{t ∈ 𝒯} {α}^{t} \cdot {R}_{w}^{t} + {R}_{w} ∀ w ϵ [ 1 , W ]$$

### Update of Full-Time Part-Time Ratio

In embodiments, the updating of the full-time part-time ratio may be modeled as follows:

$$( {\sum }_{t ↔ FT , l \leq w} ( {x}^{{h}_{w}^{t , l}} - {r}_{w}^{t , l} ) + {\sum }_{t ↔ FT , t ∈ 𝒯} ( {\sum }_{l ∈ [ 1 , {η}^{t} ]} ( {X}^{{r}_{w}^{t , l}} + {X}^{{o}_{w}^{t , l}} ) - {R}_{w}^{t} ) + ( ( {S}_{w}^{FT} - {\sum }_{t ↔ FT , t ∉ 𝒯} {α}^{t} \cdot {h}^{t} \cdot {Z}_{w}^{t} ) - {R}_{w} ) ) - {ρ}_{FP} \cdot ( {\sum }_{t ↔ PT , l \leq w} ( {x}^{{h}_{w}^{t , l}} - {r}_{w}^{t , l} ) + {\sum }_{t ↔ PT , t ∈ 𝒯} ( {\sum }_{l ∈ [ 1 , {η}^{t} ]} ( {X}^{{r}_{w}^{t , l}} + {X}^{{o}_{w}^{t , l}} ) - {R}_{w}^{t} ) + ( ( ( {S}_{w} - {S}_{w}^{FT} ) - {\sum }_{t ↔ PT , t ∉ 𝒯} {α}^{t} \cdot {h}^{t} \cdot {Z}_{w}^{t} ) - {R}_{w} ) ) = {φ}_{w} - {ϕ}_{w} ∀ w ϵ [ 1 , W ]$$

Note that −r_{w}^{t,l}, −R_{w}^{t}, and −R_{w} correspond to a parametrized variant for the ratio computation based on the net hours, net of the PTO releases.

### Additional Terms in the Objective Function

Embodiments of the labor contract planning model 220 may include and/or otherwise incorporate one or more of the following additional independent terms in the objective function: the X_{w}^{rt} times the corresponding “base rate”; the −h^{t}·Z_{w}^{t}, t∉ [symbol] times the corresponding “base rate”; the XV times the corresponding “additional cost”; and/or the slacks related to the soft released PTO constraints.

### Carry-Over Relationships

In embodiments, if the carry-ins contain x identical contracts that must go on at least to m and at most to M additional weeks, then the labor contract planning model 220 may include and/or create an artificial contract τ with m^{τ}=m and M^{τ}=M, to which the following constraint may be added: o₁^{τ}=x, (o_{w}^{τ} defined only for w=1 and c_{w}^{τ} defined only for w∈[m^{τ}, M^{τ}].). In such embodiments, there may be no cost associated to this “artificial opening”.

If the carry-ins contain x identical contracts that can be prolongated or not and go on at most to M additional weeks, then the labor contract planning model 220 may include and/or create an artificial contract i with m^{τ}=1 and M^{τ}=M, to which the following constraint may be added: o₁^{τ}<x, (o_{w}^{τ} defined only for w=1 and c_{w}^{τ} defined only for w≤M^{τ}) with a closing cost proportional to x−o₁^{τ}.

In embodiments of the problem statement, the initial conditions may be reduced to “supply” by t contract. Since the opening times/dates of the corresponding contracts may be unknown, embodiments of the labor contract planning model 220 may be structured to assume that such contracts reached their minimum m^{t} the week before the planning period. As a result, an artificial contract can be considered in the same and/or a similar condition as carry-ins containing x identical contracts that can be prolongated or not and go on at most to M additional weeks, e.g., m^{τ}=1 and M^{τ}=M^{t}−m^{t}.

Expand open and close decisions in specific contract instances In embodiments, if there are no [start, end] preferences expressed by the employees to be hired during the planning period, then the chronological greedy assignment of the first unassigned opened contract to the first unassigned closed contract may be proposed. In embodiments, if there are [start, end] preferences related typically to the length maximization/minimization by target start or end, then the expansion can be solved through an extended assignment problem over individual potential employees e, developed contract openings o and developed contract closings c, i.e., and with x_{eoc} assignment variables weighted with/by individual C_{eoc}. More generally, the PTOs may be a dimension considered in the extended assignment according to the potential PTO preferences.

### Propositions and Demonstrations of Constraints as Necessary and Sufficient Conditions

The current disclosure will now provide non-limiting examples demonstrating that the constraints disclosed herein are necessary and sufficient conditions.

### Open/Close and Forward Propositions

As will be understood, in embodiments, the following relationships may hold but may not be part of the constraints in the labor contract planning model 220.

### By Definition:

$${ℱ}^{{o}_{w}^{t}} = {\sum }_{{w}^{′} \leq w} {o}_{{w}^{′}}^{t} ∀ w ϵ [ l , W ] , t$$

$$⇔ {ℱ}^{{o}_{w}^{t}} = {ℱ}^{{o}_{w - 1}^{t}} + {o}_{w}^{t} ∀ w ϵ [ 2 , W ] , t AND {ℱ}^{{o}_{1}^{t}} = {o}_{1}^{t}$$

$$⇔ {\sum }_{{w}^{′} ∈ [ {w}_{1} , {w}_{2} ]} {o}_{{w}^{′}}^{t} = {ℱ}^{{o}_{{w}_{2}}^{t}} - {ℱ}^{{o}_{{w}_{1} - 1}^{t}} ∀ {w}_{1} ϵ [ 2 , W ] , {w}_{2} ϵ [ {w}_{1} , W ] , t$$

$${ℱ}^{{c}_{w}^{t}} = {\sum }_{{w}^{′} \leq w} {c}_{{w}^{′}}^{t} ∀ w ϵ [ {m}^{t} , W ] , t$$

$$⇔ {ℱ}^{{c}_{w}^{t}} = {ℱ}^{{c}_{w - 1}^{t}} + {c}_{w}^{t} ∀ w ϵ [ {m}^{t} + 1 , W ] , t AND {ℱ}^{{c}_{{m}^{t}}^{t}} = {c}_{{m}^{t}}^{t}$$

$$⇔ {\sum }_{{w}^{′} ∈ [ {w}_{1} , {w}_{2} ]} {c}_{{w}^{′}}^{t} = {ℱ}^{{c}_{{w}_{2}}^{t}} - {ℱ}^{{c}_{{w}_{1} - 1}^{t}} ∀ {w}_{1} ϵ [ 2 , W ] , {w}_{2} ϵ [ {w}_{1} , W ] , t$$

Note the opening cost may be applied to o_{w}^{t}, and that, in embodiments, only constraints corresponding the second and fifth relationships are necessary.

Any opened contract must be closed in its valid range and vice versa (v.v.).: In embodiments, the number of t contracts closed over [w+m^{t-}, w+M^{t-}] is greater than or equal to the number of t contracts opened at w:

$${ℱ}_{w + {M}^{t -}}^{{c}^{t}} - {ℱ}_{w + {M}^{t}}^{{c}^{t}} \geq {o}_{w}^{t} ∀ w ϵ [ 1 , W - {M}^{t -} ] , t$$

Further, in embodiments, the number of t contracts opened over [max(1, w−M^{t-}) w−m^{t}−] is greater than or equal to the number of t contracts closed at w∈[m^{t}, W^{t}]:

$${ℱ}_{w - {m}^{t}}^{{o}^{t}} - {ℱ}_{max ( 0 , w - {M}^{t} )}^{{o}^{t}} \geq {c}_{w}^{t} ∀ w ∈ [ {m}^{t} , W ] , t$$

Note that constraints corresponding to these relationships may not be necessary but could be added as “cuts”.

### Forward Relationships

This proposition may be a variant of forward-backward constraints and used to schedule efficiently breaks inside shifts. In embodiments, it may have the advantage of not requiring a delicate formulation where the number of closings is equal to the number of openings. As will be appreciated, necessarily all t contracts opened at or before w must be closed at or before w+M^{t-}, where:

$${ℱ}_{w + {M}^{t -}}^{{c}^{t}} \geq {ℱ}_{w}^{{o}^{t}} ∀ w ϵ [ 1 , W - {M}^{t -} ] , t$$

Note that this may not be equivalent to [symbol] _{min(w+M}_{^{t−}}_{,w)}^{c}^{^{t}}≥ [symbol] _{w}^{o}^{^{t}} ∀wϵ[1, W], t since opened contracts in the planning period are not necessary closed there.
As will be further appreciated, necessarily: all t contracts closed at or before w+m^{t-} must be opened at or before w, where:

$${ℱ}_{w + {m}^{t -}}^{{c}^{t}} \leq {ℱ}_{w}^{{o}^{t}} ∀ w ϵ [ 1 , W - {m}^{t -} ] , t$$

Note that this may be equivalent to [symbol] _{min(w+m}_{^{t−}}_{,w)}^{c}^{^{t}}≤ [symbol] _{w}^{o}^{^{t}} ∀wϵ[1, W], t since [symbol] _{w}^{o}^{^{t}} never decreases with w by definition. Further, equivalently it can be seen by simple index substitutions than these necessarily conditions can be:

$${ℱ}_{w - {M}^{t -}}^{{o}^{t}} \leq {ℱ}_{w}^{{c}^{t}} ∀ w ϵ [ {M}^{t} , W ] , t$$

$$and$$

$${ℱ}_{w}^{{c}^{t}} \leq {ℱ}_{w - {m}^{t -}}^{{o}^{t}} ∀ w ϵ [ {m}^{t} , W ] , t$$

Note it may be implicit that these statements hold if and only if the w upper bound is not smaller than its lower bound.

At least as many open contracts as closed contracts at any week

$${ℱ}_{w}^{{o}^{t}} - {ℱ}_{max ( w , {m}^{t} )}^{{c}^{t}} \geq 0 ∀ w ϵ \{ 1 , … , W \} , t$$

### Double Forward Model Validation

In embodiments, the forward relationships between open and closed contracts may be necessary conditions to be able to expand the resulting opening/closing plan in a set of valid concrete contracts. For example:

$${ℱ}_{min ( w + {m}^{t -} , W )}^{{c}^{t}} \leq {ℱ}_{w}^{{o}^{t}} ∀ w ϵ [ 1 , W ] , t \qquad ( 1 )$$

$${ℱ}_{w + {M}^{t -}}^{{c}^{t}} \geq {ℱ}_{w}^{{o}^{t}} ∀ w ϵ [ 1 , W - {M}^{t -} ] , t \qquad ( 2 )$$

As will be appreciated, the following proposition shows that the forward relationships between open and closed contracts may also be sufficient conditions: the openings and closings of a same type t can be paired (such that their length∈[m^{t}, M^{t}]) chronologically up to the last closing. The possible remaining unpaired openings could then be paired with a closing after the planning period (i.e., wₒ_{^{t}}+M^{t-}>W).

### Demonstration

As will be appreciated, the foregoing propositions can be proven by induction as shown in the following non-limiting example:

The first opening w₁^{o}^{^{t}} can be combined to the first closing w₁^{c}^{^{t}} if the latest exists, otherwise it could be paired with a closing after the planning period (e. g., w₁^{o}^{^{t}}+M^{t-}>W.) where:

$${w}_{1}^{{o}^{t}} is the first opening$$

$$⇔$$

$${ℱ}_{{w}_{1}^{{o}^{t}} - 1}^{{o}^{t}} = 0 \qquad ( 3 )$$

$$and$$

$${ℱ}_{{w}_{1}^{{o}^{t}}}^{{o}^{t}} \geq 1 \qquad ( 4 )$$

$$( \geq 1 and not = 1 because more than one contract can be opened at {w}_{1}^{{o}^{t}} )$$

$$( 1 ) ⇒ {ℱ}_{min ( {w}_{1}^{{o}^{t}} + {m}^{t} - 2 , W )}^{{c}^{t}} \geq {ℱ}_{{w}_{1}^{{o}^{t}} - 1}^{{o}^{t}} AND ( 3 ) ⇒ {ℱ}_{min ( {w}_{1}^{{o}^{t}} + {m}^{t} - 2 , W )}^{{c}^{t}} = 0$$

$$⇒$$

$${w}_{1}^{{c}^{t}} ∉ [ 1 , {w}_{1}^{{o}^{t}} + {m}^{t} - 2 ] or it does not exist \qquad ( 5 )$$

If w₁^{o}^{^{t}}≤W−M^{t-}, then w₁^{o}^{^{t}} can be paired, thus:

$$( 2 ) ⇒ {ℱ}_{{w}_{1}^{{o}^{t}} + {M}^{t -}}^{{o}^{t}} \geq {ℱ}_{{w}_{1}^{{o}^{t}}}^{{o}^{t}} AND ( 4 ) ⇒ {ℱ}_{{w}_{1}^{{o}^{t}} + {M}^{t -}}^{{o}^{t}} \geq 1 \qquad ( 6 )$$

$$⇒$$

$${w}_{1}^{{c}^{t}} ∈ [ 1 , {w}_{1}^{{o}^{t}} + {M}^{t -} ] and exists$$

(5) and (6)

$$⇒$$

$${w}_{1}^{{c}^{t}} ∈ [ {w}_{1}^{{o}^{t}} + {m}^{t -} , {w}_{k}^{{o}^{t}} + {M}^{t -} ]$$

and the pairing is possible QED 1.1

Else if w₁^{o}^{^{t}}>W−M^{t-} and if w₁^{c}^{^{t}} exists, then w₁^{o}^{^{t}} can be paired, thus:
w₁^{c}^{^{t}} exists

$$⇔$$

$${w}_{1}^{{c}^{t}} ∈ [ 1 , W ] and exists$$

$$WITH ( 5 )$$

$$⇒$$

$${w}_{1}^{{c}^{t}} ∈ [ {w}_{1}^{{o}^{t}} + {m}^{c -} , W ]$$

and the pairing is possible QED 1.2

Else if w₁^{o}^{^{t}}>W−M^{t-} and if w₁^{c}^{^{t}} does not exist, then w₁^{o}^{^{t}} could be paired after the planning period, thus:

$${w}_{1}^{{c}^{t}} does not exist$$

$$⇔$$

$$⇔$$

$${ℱ}_{W}^{{c}^{t}} = 0$$

$$( 2 ) ⇒ {ℱ}_{W}^{{c}^{t}} \geq {ℱ}_{W - {M}^{t -}}^{{o}^{t}} = 0$$

$$⇒$$

$${w}_{1}^{{o}^{t}} ∈ [ W - {M}^{t} , W ] and {w}_{1}^{{o}^{t}} + {M}^{t -} > W$$

w₁^{o}^{^{t}} could then be paired outside the planning period QED 1.3

If the (k−1) the opening wₖ₋₁^{o}^{^{t}} can be combined to the (k−1)^{th} closing wₖ₋₁^{c}^{^{t}} if the latest exists, then the kth opening wₖ^{o}^{^{t}} can be combined to the kth closing wₖ^{c}^{^{t}} if the latest exists, otherwise it could be paired with a closing after this planning period (i. e., wₖ^{o}^{^{t}}+M^{t-}>W), thus:

$${w}_{k}^{{o}^{t}} is the {k}^{th} opening$$

$$⇔$$

$${ℱ}_{{w}_{k}^{{o}^{t}} - 1}^{{o}^{t}} \leq k - 1 \qquad ( 7 )$$

$$AND$$

$${ℱ}_{{w}_{k}^{{o}^{t}}}^{{o}^{t}} \geq k \qquad ( 8 )$$

$$( \geq k and not = k because more than one contract can be opened at {w}_{k}^{{o}^{t}} )$$

$$( 1 ) ⇒ {ℱ}_{min ( {w}_{k}^{{o}^{t}} + {m}^{t} - 2 , W )}^{{c}^{t}} \leq {ℱ}_{{w}_{k}^{{o}^{t}} - 1}^{{o}^{t}} AND ( 7 ) ⇒ {ℱ}_{min ( {w}_{k}^{{o}^{t}} + {m}^{t} - 2 , W )}^{{c}^{t}} \leq k - 1$$

$$⇒$$

$${w}_{k}^{{c}^{t}} ∉ [ 1 , {w}_{k}^{{o}^{t}} + {m}^{t} - 2 ] or it does not exist \qquad ( 9 )$$

If wₖ^{o}^{^{t}}≤W−M^{t-}, then wₖ^{o}^{^{t}} can be paired, thus:

$$( 2 ) ⇒ {ℱ}_{{w}_{k}^{{o}^{t}} + {M}^{t -}}^{{c}^{t}} \geq {ℱ}_{{w}_{k}^{{o}^{t}}}^{{o}^{t}} AND ( 8 ) ⇒ {ℱ}_{{w}_{k}^{{o}^{t}} + {M}^{t -}}^{{c}^{t}} \geq k$$

$$⇒$$

$${w}_{k}^{{c}^{t}} ∈ [ 1 , {w}_{k}^{{o}^{t}} + {M}^{t -} ] and exists \qquad ( 10 )$$

(9) and (10)

$$⇒$$

$${w}_{k}^{{c}^{t}} ∈ [ {w}_{k}^{{o}^{t}} + {m}^{t -} , {w}_{k}^{{o}^{t}} + {M}^{t -} ]$$

and the pairing is possible QED 2.1

Else if wₖ^{o}^{^{t}}>W−M^{t-} and if wₖ^{c}^{^{t}} exists, then wₖ^{o}^{^{t}} can be paired, thus:
wₖ^{c}^{^{t}} exists

$$⇔$$

$${w}_{k}^{{c}^{t}} ∈ [ 1 , W ] and exists$$

$$WITH ( 5 )$$

$$⇒$$

$${w}_{1}^{{c}^{t}} ∈ [ {w}_{1}^{{o}^{t}} + {m}^{t -} , W ]$$

and the pairing is possible QED 2.2

Else if wₖ^{o}^{^{t}}>W−M^{t-} and if wₖ^{c}^{^{t}} does not exist, then wₖ^{o}^{^{t}} could be paired after the planning period, thus:
wₖ^{c}^{^{t}} does not exist and wₖ₋₁^{c}^{^{t}} exists

$$⇒$$

$${ℱ}^{{c}_{W}^{t}} = k - 1$$

$$( 2 ) ⇒ {ℱ}^{{c}_{W}^{t}} \geq {ℱ}^{{o}_{W - {M}^{t -}}^{t}} = k - 1$$

$$⇒$$

$${w}_{k}^{{o}^{t}} ∈ [ W - {M}^{t} , W ] and {w}_{1}^{{o}^{t}} + {M}^{t -} > W$$

wₖ^{o}^{^{t}} could then be paired outside the planning period QED 2.3

If there is no (k−1)^{th} closing, but wₖ₋₁^{o}^{^{t}} could be paired with a closing after the planning period (i. e., wₖ₋₁^{o}^{^{t}}+M^{t}−>W), then the kth opening wₖ^{o}^{^{t}} could be paired with a closing after this planning period (i. e., wₖ^{o}^{^{t}}+M^{t-}>W).

If there is no (k−1) for the closing, then of course there is no kth closing.

If wₖ₋₁^{o}^{^{t}}+M^{t}−>W, then since wₖ^{o}^{^{t}}≥wₖ₋₁^{o}^{^{t}}+M^{t-}>W QED 3 QED 1 (=QED 1.1+QED 1.2+QED 1.3), QED 2 (=QED 2.1+QED 2.2+QED 2.3), and QED 3 cover all the possibilities, then by induction valid chronological pairing for a given contract type is always possible up to the last closings. After, the remaining openings could always be paired with some closings after the planning period. QED

### Conversion of any Contract Plan in the Chronological One

Embodiments of the labor contract planning model 220 may be structured based at least in part on the following proposition:
Any feasible contract plan of a given type t can be converted in a chronological one, that is also feasible. A feasible t contract plan contains a set of (opening week, closing week) such that the pair length∈[m^{t}, W^{t}]. A feasible plan could also contain a set of unassigned opening weeks that could be all paired to a closing week after the planning period. The chronological contract plan, is the plan obtained by pairing the first opening week to the first closing week, the second opening week to second closing week, and so on up to using all the closing weeks. The possible remaining unpaired opening weeks could all be paired with a closing week after the planning period.

Indeed, each local chronological inversion can be fixed by a simple permutation that still respects the contract length bounds.

For example, suppose there is a local transgression implying w₁, w₂, w₃, and w₄ strictly chronologically ordered where (w₁, w₄) defined the first feasible contract and (w₂, w₃) the second feasible contract. Then the contracts (w₁, w₃) and (w₂, w₄) are necessarily feasible since their lengths are respectively both greater and both shorter than the shortest length and the longest of the original solution, which is feasible.

Embodiments may have local transgression implying w₅, w₆, and w₇ strictly chronologically ordered where {w₅} is not paired but could be paired with a closing week after the planning period and where (w₆, w₇) defines a feasible contract. In such a case, (w₅, w₇) is necessarily feasible and {w₆} could necessarily be paired with a closing week after the planning period.

### Refined PTO Release

In embodiments, the PTO release policy as expressed by the LP component of may be a valuable necessary condition for allowing employees to take vacation during unavoidable overcoverage periods but it is clearly insufficient. For instance, respecting the policy rules does not prevent the engine/model from releasing PTO only during the last weeks of a planning/planification period, thereby preventing early terminating/ending contracts from receiving any PTOs while offering superfluous possibilities for the late terminating/ending contracts or contracts with overlapping terminations/ending times.

### Contract PTO Concepts

PTOs, as referred to herein, may include personal time offs that employees may take during their contract spans. The amount of PTOs corresponding to a given employee depends on the employee contract type and their assigned weekly hours or nominal weekly hours (according to their contract: the minimum weekly hours for instance). As disclosed herein, embodiments of the labor contract planning model 220 may be structured to propose a PTO release plan through which the individual employees would take their own PTOs. In some contexts, the ungranted PTOs can be replaced by a monetary compensation. Semantically, PTOs are earned, accrued, and released.

Earned PTOs, e_{w}^{t}= [symbol] ^{t}·x_{w}^{h}^{^{t}} (or [symbol] ^{t}·x_{w}^{c}^{^{t}}), may correspond to a specific week and to an assigned/normal hours worked during this week. Earned PTOs may be cumulated from the beginning of the planning period, see [symbol] _{w}^{e}^{^{t}}.

Released PTOs, r_{w}^{t}, are PTOs that may be made available for employees to take and, in embodiments, they may correspond to a given week value. Released PTOs can be cumulated from the beginning of the planning period, see [symbol] _{w}^{r}^{^{t}}. In embodiments, valuable, released PTOs at the contract type level may be globally assignable to each contract instance in accordance with their span and to their individual earned amount.

Accrued PTOs, a_{w}^{t}, are PTO earned amounts over a given set of accrual periods partitioning the time horizon. The accruals occur at the period starts and correspond to the cumulated earned values over the period: a_{w}_{ₚ}_{^{s}}^{t}= [symbol] _{w}_{ₚ}_{^{e}}^{e}^{^{t}}− [symbol] _{w}_{ₚ}_{^{s−}}^{e}^{^{t}}. Accrued PTOs are positive only on these period starts (they are null elsewhere). Accrued PTOs over a given week can only be released from this week on up to the end of the corresponding release period. Accrued PTOs can be cumulated from the beginning of the planning period, see [symbol] _{w}^{a}^{^{t}}. As will be appreciated, the following statement holds for the accrual period ends wₚ^{e}: [symbol] _{w}_{ₚ}_{^{e}}^{a}^{^{t}}= [symbol] _{w}_{ₚ}_{^{e}}^{e}^{^{t}}.

In embodiments, PTO to Release, b_{w}^{t}, is the residual of the cumulated accrued minus the cumulated release: b_{w}^{t}= [symbol] _{w}^{r}^{^{t}}− [symbol] _{w}^{a}^{^{t}}. On cyclic periods, called release periods, it may be aimed to release all the PTOs: b_{w}_{ₚ}_{^{e}}^{t} [symbol] 0, and the release periods partitions the time horizon.

In embodiments, there may be a business logic behind the accrual and release period concepts.

In embodiments, the accrual periods allow for control of the global advance on earned PTOs that the company allows its employees to take. If the accrual periods are yearly, then the employees could, in theory, take all their projected earned PTOs at the very beginning of the year even if they have not yet earned that time. If these periods are weekly, then employees must have earned their PTO hours before they can take them.

As will be appreciated, in embodiments, the release periods allow for the defining of time axis milestones when the company aims to get rid of PTO individual debt. Note that, in general, the release periods are adjacent but that they may be separated by “no release periods”, where r_{w}^{t}=0.

### Contract Instance PTO Rules

In embodiments, the natural implicit rule may be that: released PTOs at contract type level should be globally assignable to each contract instance in accordance with their span and to their individual earned amount over this span. Such a rule implies that it could be possible to virtually assign earned PTOs inside the contract spans.

Other instance rules may be given by the transposition of their contract type rules. For example, the concepts of accrual and release periods can be transposed to individual instances. In particular, the transposition can be done by considering, as a reference, the open week of the contract instance instead of a global reference across the instances.

In embodiments, the accrual and release periods defined by the instance span may be considered. Additionally, the accrual periods could be weekly, monthly, quarterly, half-yearly, yearly, etc., using the instance start week as a reference. The release periods may follow a similar pattern but should contain one or more accrual periods.

In embodiments, there may be a no release period at the beginning of the span and/or a no release period at the end of the span to reflect that a new hire cannot take PTO at the very beginning of his contracts and/or to reflect that a leaving employee cannot take PTO after his last working day.

As will be understood, any of the instance rules, disclosed herein, can either be based on assigned or nominal weekly hours. Respecting the assigned based PTO earning may necessarily require respecting the nominal based PTO earning (which requires separate assigned and nominal release variables).

### Consistency Linear Programing (Lp) Components at Instance Level

In embodiments, the most relaxed consistency condition of the release plan may be that possible individual contract instances can be virtually assigned the PTOs earned based on the nominal weekly hours (instead of the assigned weekly hours). For example, in such a scenario, the labor contract planning model 220 may have: parameter: i⇔a contract instance of type tᵢ, length lᵢ, opened at [symbol] ᵢ and closed at [symbol] ᵢ; and variables: [symbol] _{w}^{r}^{^{t}}⇔the cumulative pto release at week w for contract type t; ε_{w}^{o}^{^{t}}, wϵ[1, W−m^{t-}]⇔the cumulative earned PTOs by t contract instances opened at or before w⇔the cumulative instance accrued amount that must have been released at week w or before if the instance accrual periods are defined by their spans; ε_{w}^{c}^{^{t}}, wϵ[m^{t}, W] the cumulative earned PTOs by t contract instances closed at or before w the exact cumulative instance accrued amount at week w if the instance accrual periods are defined by their spans; and/or xᵢ^{t}⇔the number of i contract instances of type t; and the following definition and consistency constraints:

$$\begin{matrix}{\sum }_{i : {ℴ}_{i} = w ∧ {c}_{i} \leq W} {x}_{i}^{t} = {o}_{w}^{t} & ∀ w ϵ [ 1 , W - {m}^{t -} ] , t \\ {\sum }_{i : {c}_{i} = w} {x}_{i}^{t} = {c}_{w}^{t} & ∀ w ϵ [ {m}^{t} , W ] , t \\ {ℱ}_{1}^{{τ}^{t}} = {r}_{1}^{t} & ∀ t \\ {ℱ}_{w}^{{τ}^{t}} = {ℱ}_{w - 1}^{{τ}^{t}} + {r}_{w}^{t} & ∀ w ϵ [ 2 , W ] , t \\ {ℰ}_{{m}^{t}}^{{c}^{t}} = {ϱ}^{t} \cdot {m}^{t} \cdot {c}_{{m}^{t}}^{t} & ∀ t \\ {ℰ}_{w}^{{c}^{t}} = {ℰ}_{w - 1}^{{c}^{t}} + {ϱ}^{t} \cdot {\sum }_{i : {c}_{i} = w} {l}_{i} \cdot {x}_{i}^{t} & ∀ w ϵ [ {m}^{t} + 1 , W ] , t \\ {ℰ}_{1}^{{o}^{t}} = {ϱ}^{t} \cdot {o}_{1}^{t} & ∀ t \\ {ℰ}_{w}^{{o}^{t}} = {ℰ}_{w - 1}^{{o}^{t}} + {ϱ}^{t} \cdot {\sum }_{i : {ℴ}_{i} = w} {l}_{i} \cdot {x}_{i}^{t} & ∀ w ϵ [ 2 , W - {m}^{{t}^{-}} ] , t \\ {ℰ}_{w}^{{c}^{t}} \leq {ℱ}_{w}^{{r}^{t}} & ∀ w ϵ [ {m}^{t} , W ] , t \\ {ℱ}_{w}^{{r}^{t}} \leq {ℰ}_{w}^{{o}^{t}} & ∀ w ϵ [ 1 , W - {m}^{{t}^{-}} ] , t\end{matrix}$$

As will be understood, the last two constraints may be apparently necessarily and sufficient conditions to ensure the feasibility of the release plan (which should be proved by induction).

While this LP component does not seem to be adaptable to consider the assigned weekly hours instead of nominal weekly hours, this does not mean that this component is useless in this context. Indeed, this component can at least be used to correctly distribute the nominal part of these releases: the distribution of the remaining part may still be controlled by the general component. Of course, however, the release variable should then be duplicated in r_{w}ⁿ^{^{t}} and r_{w}^{a}^{^{t}}, constrained separately, but linked by inequality constraints r_{w}ⁿ^{^{t}}<r_{w}^{a}^{^{t}}.

In embodiments, the size of the labor contract planning model 220 may be significantly increased by the following component(s): the xᵢ^{t} variables and the linked constraints size is the order of: T×W×W.

### Necessary Conditions at the Contract Type Level

In embodiments, the labor contract planning model 220 may have: variables [symbol] _{w}^{r}^{^{t}}⇔the cumulative pto release at week w for contract type t; and [symbol] _{w}^{e}^{^{t}}⇔the cumulative pto earned at week w for contract type t, being either assigned or nominal weekly hours based. In such embodiments, the following constraints may be necessary:

$$\begin{matrix}{ℱ}_{w - {M}^{{t}^{-}}}^{{e}^{t}} \leq {ℱ}_{w}^{{r}^{t}} & ∀ w ϵ [ {M}^{t} , W ] , t \\ {ℱ}_{w}^{{r}^{t}} \leq {ℱ}_{w + {M}^{t}}^{{e}^{t}} & ∀ w ϵ [ 1 , W - {M}^{{t}^{-}} ] , t \\ With : & \\ {ℱ}_{1}^{{r}^{t}} = {r}_{1}^{t} & ∀ t \\ {ℱ}_{w}^{{r}^{t}} = {ℱ}_{w - 1}^{{r}^{t}} + {r}_{w}^{t} & ∀ w ϵ [ 2 , W ] , t \\ {ℱ}_{1}^{{e}^{t}} = {ϱ}^{t} \cdot {x}_{1}^{{h}^{t}} & ∀ t \\ {ℱ}_{w}^{{e}^{t}} = {ℱ}_{w - 1}^{{e}^{t}} + {ϱ}^{t} \cdot {x}_{w}^{{h}^{t}} & ∀ w ϵ [ 2 , W ] , t\end{matrix}$$

As will be further understood, in embodiments, the nominal based earning is obtained by replacing x_{w}^{h}^{^{t}} by x_{w}^{c}^{^{t}}. As such, these necessary conditions are not sufficient. For instance, consider a contract type with two (2) PTO hours earned by week and length bounded by eight (8) weeks and sixteen (16) weeks. Suppose the solution includes two instances with respective spans of week one (1) to week eight (8) and week ten (10) to week eighteen (18). In such a case, the release plan thirty-two (32) hours on week ten (10) fulfils the necessary conditions (plus the constraint enforcing to have no more PTOs released than assigned hours) but does not allow a feasible assignment for the two instances: the week one (1) to week eight (8) instance would not receive any PTO while the week ten (10) to week eighteen (18) will receive would receive twice of its entitled amount.

As a result, these necessary conditions are not sufficient but are still valuable since they avoid certain infeasibilities, e.g., assigning the required amount of PTO to each contract and vice versa. Additionally, these conditions are often more flexible than the ones set at the instance level since they can apply to both assigned and nominal based earning options.

In embodiments, a heuristic approach may include replacing M^{t} by m^{t} in the first inequality constraint ( [symbol] _{w-m}_{^{t−}}^{e}^{^{t}}≤ [symbol] _{w}^{r}^{^{t}}). This heuristic corresponds to sufficient but not necessary conditions to warranty the existence of a feasible assignment of the releases to instances. It should be noted, however, that this approach may over tighten the solution space, but such over-tightening may be far less severe than imposing immediate release constraints ( [symbol] _{w}^{r}^{^{t}}= [symbol] _{w}^{e}^{^{t}}). Embodiments may also use

$$\frac{{m}^{t} + {M}^{t}}{2} .$$

### Sophisticated PTO Release Instance Level

Embodiments of the current disclosure may include and/or otherwise facilitate a transposition of the overall accrual and release periods at the instance level. For example, if the PTO earning is based on nominal weekly hours, then the general problem can be reformulated through a specific set of parameters by contract instance. In such embodiments, the labor contract planning model 220 may be structured to include and/or otherwise incorporate parameters: k⇔the chronological rank of an accrual period of any contract instance (k is necessarily bounded by the greatest accrual period number that any contract instance can have.); j⇔the chronological rank of a release period of any contract instance (j is necessarily bounded by the greatest release period number that any contract instance can have.); K^{tj}⇔the set of accrual period ranks associated to the release period rank j for t contracts. The k^{th} accrual period must terminate inside the j^{th} release period; oᵢ^{j}⇔the j^{th} release period start week of contract instance i; cᵢ^{j}⇔the j^{th} release period end week of contract instance i; and/or βᵢ^{k}⇔the k^{th} chronologically ranked accrual amount of contract instance i. Typically, βᵢ^{k}=0 for k≥a certain value. The total Σₖβᵢ^{k} corresponds to the total PTO earned by i. In such embodiments, the cumulated instance accrual amount for j^{th} release periods that must have been released at week w or before may be modeled as:

$${w}_{{c}^{tj}}^{} = {\sum }_{i : {c}_{t}^{j} \leq w} {\sum }_{k ∈ {K}^{t j}} {β}_{i}^{k} ∀ w , t , j$$

and the exact accumulated instance accrual amount for l^{th} release periods at week w may be modeled as:

$${w}_{{o}^{tj}}^{} = {\sum }_{i : {o}_{i}^{j} \leq w} {\sum }_{k ∈ {K}^{t j}} {β}_{i}^{k} ∀ w , t , j$$

In such embodiments, the labor contract planning model 220 may be structured to include and/or otherwise incorporate the variable r_{w}^{tj}⇔the release amount at week w for j^{th} release periods, where the cumulated release amount for j^{th} release periods up to week w included may be modeled as:

$${ℱ}_{w}^{{r}^{tj}} = {\sum }_{w} {r}_{{w}^{′}}^{tj} ∀ w , t , j$$

As will be appreciated, the following inequalities reflect the fact that “what is to be released must be released”:

$${w}_{{c}^{tj}}^{} \leq {ℱ}_{w}^{{r}^{tj}} ∀ w , t , j$$

and the following inequalities reflect the fact that “what is released cannot be greater than what is accrued”:

$${ℱ}_{w}^{{r}^{tj}} \leq {w}_{{o}^{tj}}^{} ∀ w , t , j$$

### Mathematical Component

In embodiments, one or more of the preceding relationships may be ensured (within the labor contract planning model 220) by the following (light) constraint set:

$$\begin{matrix}{\sum }_{i : {ℴ}_{i} = w ∧ {c}_{i} \leq W} {x}_{i}^{t} = {o}_{w}^{t} & ∀ w ϵ [ 1 , W - {m}^{t -} ] , t \\ {\sum }_{i : {c}_{i} = w} {x}_{i}^{t} = {c}_{w}^{t} & ∀ w ϵ [ {m}^{t} , W ] , t \\ {{m}^{t}}_{{c}^{tj}}^{} = {\sum }_{i : {c}_{i}^{j} = {m}^{t}} {\sum }_{k ∈ {K}^{t j}} {β}_{i}^{k} & ∀ t , j \\ {w}_{{c}^{tj}}^{} = {w - 1}_{{c}^{tj}}^{} + {\sum }_{i : {c}_{i}^{j} = w} {\sum }_{k ∈ {K}^{t j}} {β}_{i}^{k} & ∀ w ϵ [ {m}^{t} + 1 , W ] , t , j \\ {{m}^{t}}_{{o}^{tj}}^{} = {\sum }_{i : {o}_{i}^{j} = 1} {\sum }_{k ∈ {K}^{t j}} {β}_{i}^{k} & ∀ t , j \\ {w}_{{o}^{tj}}^{} = {w - 1}_{{o}^{tj}}^{} + {\sum }_{i : {o}_{i}^{j} = w} {\sum }_{k ∈ {K}^{t j}} {β}_{i}^{k} & ∀ w ϵ [ 2 , W - {m}^{t -} ] , t , j \\ {ℱ}_{w}^{{r}^{tj}} = {\sum }_{{w}^{′} \leq w} {r}_{{w}^{′}}^{tj} & ∀ w , t , j \\ {w}_{{c}^{tj}}^{} \leq {ℱ}_{w}^{{r}^{tj}} & ∀ w ϵ [ {m}^{t} , W ] , t , j \\ {ℱ}_{w}^{{r}^{tj}} \leq {w}_{{o}^{tj}}^{} & ∀ wc [ 1 , W - {m}^{t -} ] , t , j\end{matrix}$$

As will be appreciated, the immediately foregoing model is a generalization and/or refinement of most of the other models, disclosed herein, in that there is only one accrual and only one release periods per instance, given by its span. Assuming a nominal weekly hour-based accrual, it is a refinement of the model disclosed under the preceding forward vs open/close variables section. Further, the immediately foregoing model can, in some instances, replace the model disclosed under the preceding forward vs open/close variables section if Γ^{t} constraints are kept (Γ^{t}⇔the maximum ratio between the released PTO hours and the supply hours). Further still, if the accrual is based on assigned weekly hours, the immediately foregoing model can still be used as a complement for the nominal parts of the assigned weekly hours (release variables should be duplicated to identify separately these parts). In such embodiments, the individual contract accrual and release parameters may be obtained directly from the instance intersection with the general [symbol] and [symbol] .

A similar problem can be formulated where the reference of the accrual and release periods is given by the start of the instance span. As such, in embodiments, necessary conditions and variants of those disclosed in the preceding Necessary conditions at the contract type level section may be used if the performance impact is an area of concern.

### Extensibility and Scalability

### Extensibility

Embodiments of the labor contract planning model 220 may rely on aggregated and/or delicate decisions. As a result, while it may not be straightforward to extend such embodiments of the labor contract planning model 220 from the mathematical formulation point of view (it may be easier to extend from the resolution standpoint, as disclosed elsewhere herein), other realistic rules or features can be supported (from a pure mathematical formulation perspective). For example, consider the following:
Rules
   Upper bound the number of openings or closings at any week or over any week span; and
   Upper and lower bound the headcount of a given type at any week.
Feature:
   The headcount of a given contract at a given week is distributed among the demanded skills set at this week.
      As will be understood, the foregoing scenario assumes that the ramp-up period terminates at or before the minimum contract length.

### Scalability

The following non-limiting example is presented to demonstrate the scalability of the various embodiments of the labor contract planning model 220, as disclosed herein. Accordingly, suppose the following: W is the size of the planning horizon and T is the number of different contract types. Then the order of the model size may be as shown below in Table 1.

TABLE 1

| | | |
|---|---|---|
| VARIABLES | | |
| | Selection variables . . . | T × W |
| | o_{w}^{t}, c_{w}^{t}, x^{c}^{^{t}}_{w} x^{h}^{^{t}}_{w} | |
| | Redundant variables . . . | T × W |
| | [symbol] ^{o}^{^{t}}_{w}, [symbol] ^{c}^{^{t}}_{w}, a_{w}^{t}, r_{w}^{t}, b_{w}^{t} | |
| CONSTRAINTS | | |
| (Non-Zeros) | | |
| | Linking Constraints | T × W (nz: T × W) |
| | Linking Constraints | T × W (nz: T × W |
| | | nz: and not T × |
| | | W × W) |
| | Coverage Constraints | W (nz: T × W) |

In other words, in embodiments, the labor contract planning model 220 includes: a multiple of T×W variables; a multiple of T×W constraints; and an a multiple of T×W non-zeros. If the problem is made of 100 weeks horizon and 10 types, the size of the model becomes: a multiple of 1000 variables; a multiple of 1000 constraints; and a multiple of 1000 non-zeros, which can be solved in few seconds by embodiments of the labor contract planning model 220.

In a non-limiting example embodiment, labor contract planning model 220 may include a MIP problem based at least in part on the following:

$$\begin{matrix}{ℱ}_{1}^{{o}^{t}} = {o}_{1}^{t} & ∀ t\end{matrix} \qquad 1 )$$

$$\begin{matrix}{ℱ}_{w}^{{o}^{t}} = {ℱ}_{w - 1}^{{o}^{t}} + {o}_{w}^{t} & ∀ w ϵ [ 2 , W ] , t\end{matrix} \qquad 2 )$$

$${ℱ}_{{m}^{t}}^{{c}^{t}} = {c}_{{m}^{t}}^{t} \qquad 3 )$$

$$\begin{matrix}{ℱ}_{w}^{{c}^{t}} = {ℱ}_{w - 1}^{{c}^{t}} + {c}_{w}^{t} & ∀ w ϵ [ {m}^{t} + 1 , W ] , t\end{matrix} \qquad 4 )$$

$$\begin{matrix}{ℱ}_{w + {m}^{t -}}^{{c}^{t}} \leq {ℱ}_{w}^{{o}^{t}} & ∀ w ϵ [ 1 , W - {m}^{t -} ] , t\end{matrix} \qquad 5 )$$

$$\begin{matrix}{ℱ}_{w + {M}^{t -}}^{{c}^{t}} \geq {ℱ}_{w}^{{o}^{t}} & ∀ w ϵ [ 1 , W - {M}^{t -} ] , t\end{matrix} \qquad 6 )$$

$$\begin{matrix}{y}_{w}^{{c}^{t , l}} = {o}_{w - l + 1}^{t} & ∀ w ϵ [ l , min ( {η}^{t} - 1 , W ) ] , l ∈\end{matrix} \qquad 7 )$$

$$[ 1 , {η}^{t} - 1 ] , t$$

$$\begin{matrix}{y}_{w}^{{c}^{t , {η}^{t}}} = {y}_{w - 1}^{{c}^{t , {η}^{t}}} + {o}_{w - {η}^{{t}_{+ 1}}}^{t} & ∀ w ϵ [ {η}^{t} , {m}^{t} - 1 ] , t\end{matrix} \qquad 8 )$$

$$\begin{matrix}{y}_{w}^{{c}^{t , {η}^{t}}} = {y}_{w - 1}^{{c}^{t , {η}^{t}}} - {c}_{w - 1}^{t} + {o}_{w - {η}^{t} + 1}^{t} & ∀ w ϵ [ {m}^{t} , W ] , t\end{matrix} \qquad 9 )$$

$$\begin{matrix}{x}^{{c}_{l}^{t , l}} = {( 1 - {β}^{t} )}^{l} \cdot {o}_{1}^{t} & ∀ l ∈ [ 1 , {η}^{t} ] , t\end{matrix} \qquad 10 )$$

$$\begin{matrix}{x}_{w}^{{c}^{t , l}} = ( 1 - {β}^{t} ) \cdot ( {x}_{w - 1}^{{c}^{t , l}} + ( {y}_{w}^{{c}^{t , l}} - {y}_{w - 1}^{{c}^{t , l}} ) ) & ∀ w ϵ [ l + 1 , W ] , l ∈\end{matrix} \qquad 11 )$$

$$[ 1 , {η}^{t} ] , t$$

$$\begin{matrix}{x}_{w}^{{c}^{t , l}} \cdot {h}^{t , l} \leq {x}_{w}^{{rh}^{t , l}} \leq {x}_{w}^{{c}^{t , l}} \cdot {h}^{{o}^{t , l}} & ∀ w ϵ [ l , W ] , l ∈ [ 1 , {η}^{t} ] , t\end{matrix} \qquad 12 )$$

$$\begin{matrix}0 \leq {x}_{w}^{{oh}^{t , l}} \leq {x}_{w}^{{c}^{t , l}} \cdot ( {H}^{t , l} - {h}^{{o}^{t , l}} ) & ∀ w ϵ [ l , W ] , l ∈ [ 1 , {η}^{t} ] , t\end{matrix} \qquad 13 )$$

$$\begin{matrix}{x}_{w}^{{h}^{t , l}} = {x}_{w}^{{rh}^{t , l}} + {x}_{w}^{{oh}^{t , l}} & ∀ w ϵ [ l , W ] , l ∈ [ 1 , {η}^{t} ] , t\end{matrix} \qquad 14 )$$

$$\begin{matrix}{\sum }_{t ↔ FT , l \leq w} {x}_{w}^{{h}^{t , l}} - {ρ}_{FP} {\sum }_{t ↔ PT , l \leq w} {x}_{w}^{{h}^{t , l}} = {φ}_{w} - {φ}_{w} & ∀ w ϵ [ 1 , W ]\end{matrix} \qquad 15 )$$

$$\begin{matrix}{\sum }_{t , l \leq w} {α}^{t} \cdot {δ}_{l}^{t} \cdot {x}_{w}^{{h}^{t , l}} \geq {d}_{w} + {\sum }_{t , l \leq w} {α}^{t} \cdot {δ}_{l}^{t} \cdot {r}_{w}^{t , l} & ∀ w ϵ [ 1 , W ]\end{matrix} \qquad 16 )$$

$$\begin{matrix}{a}_{{ω}_{p}^{s}}^{t} = {ϱ}^{t} \cdot {\sum }_{{w}^{′} ∈ p , l \leq {w}^{′}} {x}_{{w}^{′}}^{{h}^{t , l}} & ∀ p {ϵΩ}^{𝒜} , t\end{matrix} \qquad 17 )$$

$$\begin{matrix}{γ}^{t} \cdot {x}_{w}^{{h}^{t , l}} \begin{matrix}\leq \\ ( soft )\end{matrix} {r}_{w}^{t , l} \begin{matrix}\leq \\ ( hard )\end{matrix} {Γ}^{t} \cdot {x}_{w}^{{h}^{t , l}} & ∀ w ϵ [ l + 1 , W ] , l ∈\end{matrix} \qquad 18 )$$

$$[ 1 , {η}^{t} ] , t$$

$$\begin{matrix}{b}_{1}^{t} = {a}_{1}^{t} - {r}_{1}^{t , 1} & if 1 ∈ {Ω}^{𝒜 , s}\end{matrix} \qquad 19 )$$

$$\begin{matrix}{b}_{1}^{t} = 0 & if 1 ∉ {Ω}^{𝒜 , s}\end{matrix} \qquad 20 )$$

$$\begin{matrix}{b}_{w}^{t} = {b}_{w - 1}^{t} + {a}_{w}^{t} - {\sum }_{l \leq w} {r}_{w}^{t , l} & ∀ w ϵ [ 2 , W ] ⋂ {Ω}^{𝒜 , s} , t\end{matrix} \qquad 21 )$$

$$\begin{matrix}{b}_{w}^{t} = {b}_{w - 1}^{t} - {\sum }_{l \leq w} {r}_{w}^{t , l} & ∀ w ϵ [ 2 , W ] ∖ {Ω}^{𝒜 , s} , t\end{matrix} \qquad 22 )$$

$$\begin{matrix}{\sum }_{t} {b}_{ω}^{t} \begin{matrix}Dominant soft \\ =\end{matrix} 0 & ∀ ω ∈ {Ω}^{ℛ}\end{matrix} \qquad 23 )$$

$$\begin{matrix}{b}_{ω}^{t} \leq M . {\sum }_{l} {x}_{w}^{{c}^{t , l}} & ∀ w ϵ [ 1 , W ] , t\end{matrix} \qquad 24 )$$

$$\begin{matrix}{b}_{ω}^{t , l} \leq M . {x}_{w}^{{c}^{t , l}} & ∀ w ϵ [ l + 1 , W ] , t , l\end{matrix} \qquad 25 )$$

where: w⇔a week (˜100); t⇔a contract type (˜10); l⇔a proficiency level (˜2); o_{w}^{t}⇔the number of t contracts opened at the beginning of week w; c_{w}^{t}⇔the number of t contracts closed at the ending of week w≥m^{t}; x_{w}^{c}^{^{t,l}}, wϵ[l, W], l∈[1, η^{t}]⇔the actual headcounts of t contracts with a proficiency level l at the end of week w; x_{w}^{h}^{^{t,l}}, x_{w}^{rh}^{^{t,l}}, and x_{w}^{oh}^{^{t,l}}, wϵ[l, W], l∈[1, η^{t}]⇔the actual total, regular, and overtime, hours of t contracts with a proficiency level l at the end of week w; r_{w}^{t,l}, wϵ[l, W], l∈[1, η^{t}] the released PTO hours during week w for t contracts with a proficiency level l; a_{w}^{t}⇔the accrued PTO hours during a week w for t contracts (redundant); b_{w}^{t}⇔the PTO to release at the end of week w for t contracts (redundant); [symbol] ⇔a set of week periods p=[ωₚ^{s}, ωₚ^{e}] overlapping and partitioning the planning period at the start ωₚ^{s} of which the total accrued pto, over which, is associated to [symbol] ^{s}={w′:∃p∈ [symbol] :w′=ωₚ^{s}}; and [symbol] ⇔a set of weeks at which there should be no PTO to release.

In embodiments, o_{w}^{t} may be penalized. Expressions (5) and (6) correspond to open and close total inequalities ( [symbol] _{w}^{o}^{^{t}}, [symbol] _{w}^{o}^{^{t}}) (necessary and sufficient condition(s) (N.S.C.) of concrete contract existence), and for expressions (7), (8), and (9), y_{w}^{c}^{^{t,l}}, wϵ[l, W], l∈[1, η^{t}]⇔the theorical headcounts of t contracts with a proficiency level l at the end of week w. Expressions (10) and (11) correspond to actual headcount vs theorical headcount and an attrition factor. Expressions (12)-(14) correspond to actual total, regular, and overtime hours vs. actual headcounts, regular hour range, and an overtime threshold. In embodiments, x_{w}^{rh}^{^{t,l}} and x_{w}^{oh}^{^{t,l}} may be penalized. Expression (15) corresponds to a full-time/part-time ratio vs slack variables. In embodiments, φ_{w} and ϕ_{w} may be penalized. Expression (16) corresponds to efficient total hours vs. demand and released PTO hours. Expression (17) corresponds to accrued PTO at specific weeks vs. accrual rate, actual hours, and accrual periods. Expression (18) corresponds to released PTO bounded proportionally by actual hours. In embodiments,

$$\begin{matrix}\leq \\ ( soft )\end{matrix}$$

may be penalized. Expressions (19)-(22) correspond to PTO hours to release vs. previous value, accrued PTO hours and released PTO hours. Expression (23) corresponds to full PTO release at specific week(s). In embodiments, Dominant soft may be penalized. Expressions (24)-(25) correspond to PTO to release bounded proportionally by actual headcounts.

Accordingly, embodiments of the labor contract planning model 220 may support initial conditions provided in terms of supply hours and/or supply hours per contract type. Embodiments of the labor contract planning model 220 may also: account for supply hours as is; account for supply hours per contract type by assigning regular overtime hours; consider cumulated min/max fireable hours per contract type; and/or release PTOs for both supply hours and supply hours per contract type.

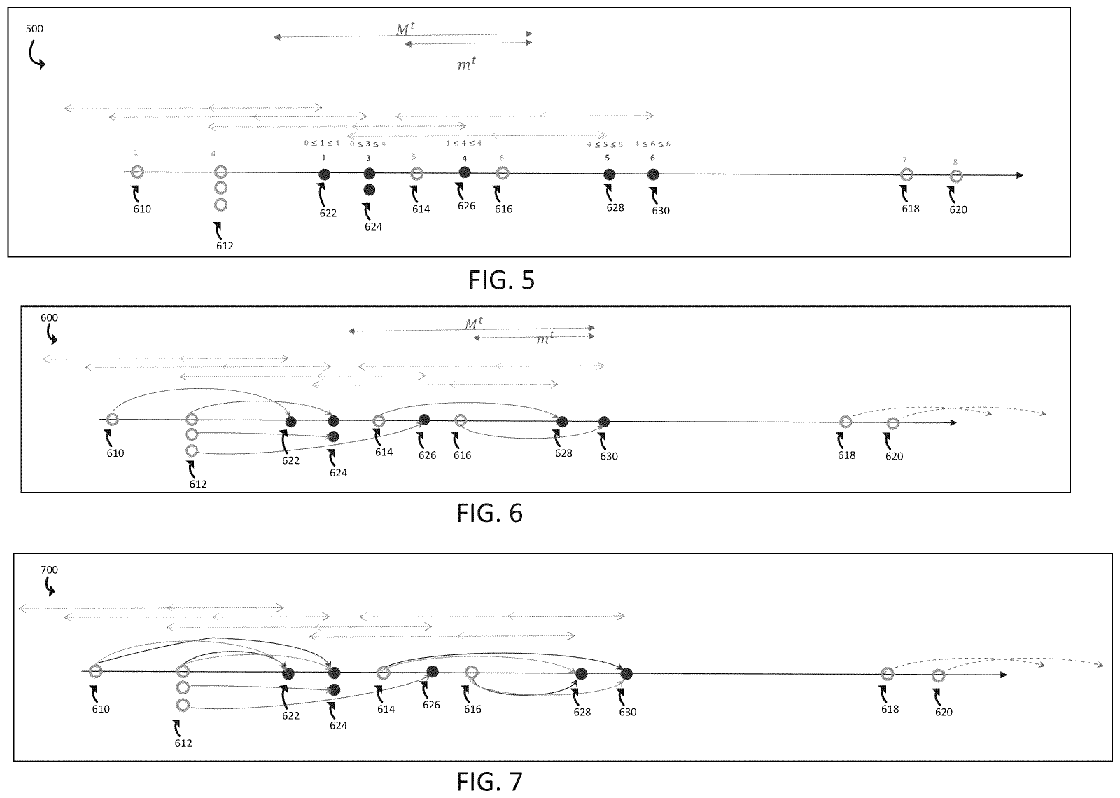

FIGS. 5, 6, and 7 respectively depict a graph of open and close total inequalities 500 (FIG. 5), open and close chronological assignment 600 (FIG. 6), and feasible open and close assignment to a chronological assignment 700 (FIG. 7). Implicit concrete contract openings are depicted by open-dots 610, 612, 614, 616, 618, and 620, and implicit contract closings are depicted by closed-dots 622, 624, 626, 628, and 630.

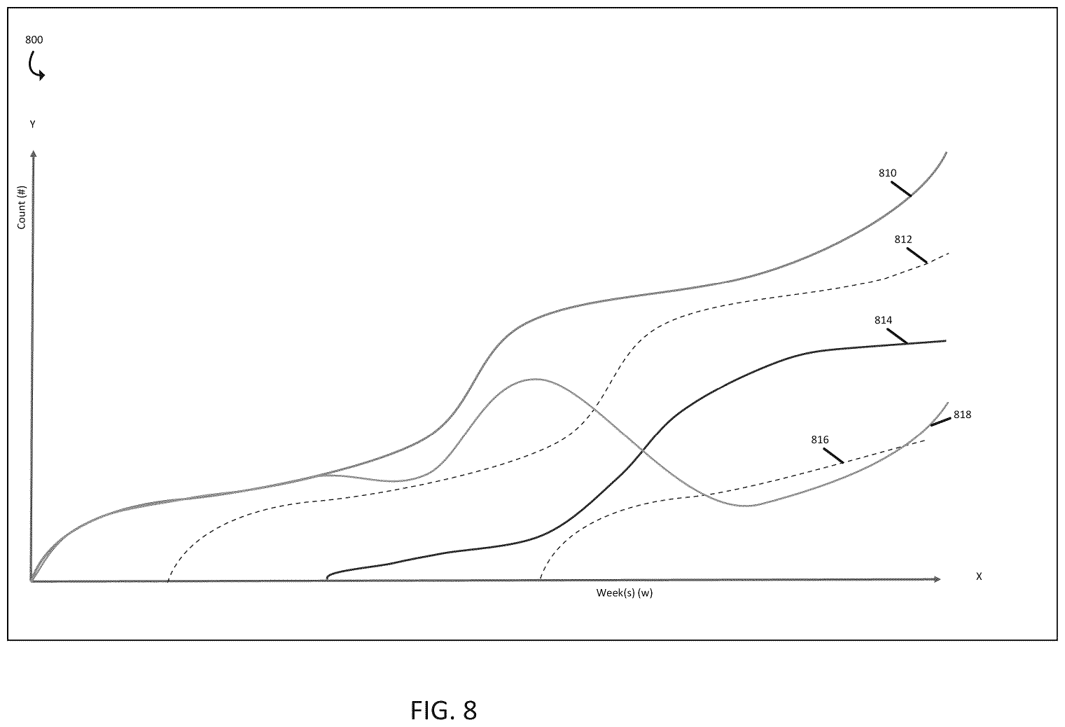

In embodiments, the graph 500 (FIG. 5) may be based at least in part on, and/or otherwise derived from, the following expression: [symbol] _{w-M}_{^{t−}}^{o}^{^{t}}≤ [symbol] _{w}^{c}^{^{t}}≤ [symbol] _{w-m}_{^{t−}}^{o}^{^{t}}, with a total openings vs total closings vs headcounts as shown by the graph 800 in FIG. 8 having lines, 810, 812, 814, 816, and 818 respectively corresponding to [symbol] _{w}^{o}^{^{t}}, [symbol] _{w-m}_{^{t−}}^{o}^{^{t}}, [symbol] _{w}^{c}^{^{t}}, [symbol] _{w-M}_{^{t−}}^{o}^{^{t}}, and y_{w}^{c}^{^{t}}= [symbol] _{w}^{o}^{^{t}}− [symbol] _{w}^{c}^{^{t}}, where lines 812 and 816 may correspond to [symbol] _{w}^{c}^{^{t}} boundaries. As will be under stood, graph 600 (FIG. 6) may be based at least in part on [symbol] _{w-M}_{^{t−}}^{o}^{^{t}}≤ [symbol] _{w}^{c}^{^{t}}≥ [symbol] _{w-m}_{^{t−}}^{o}^{^{t}}, which may correspond to the openings and closings of a same type t being paired chronologically up to the last closing (with their length E [m^{t}, M^{t}]). In embodiments, the possible remaining unpaired openings could be paired with a closing after the planning period (e.g., wₒ_{^{t}}+M^{t-}>W). The graph 700 (FIG. 7) shows that, in embodiments, any feasible contract plan of a given type t may be converted into a chronological one that is also feasible.

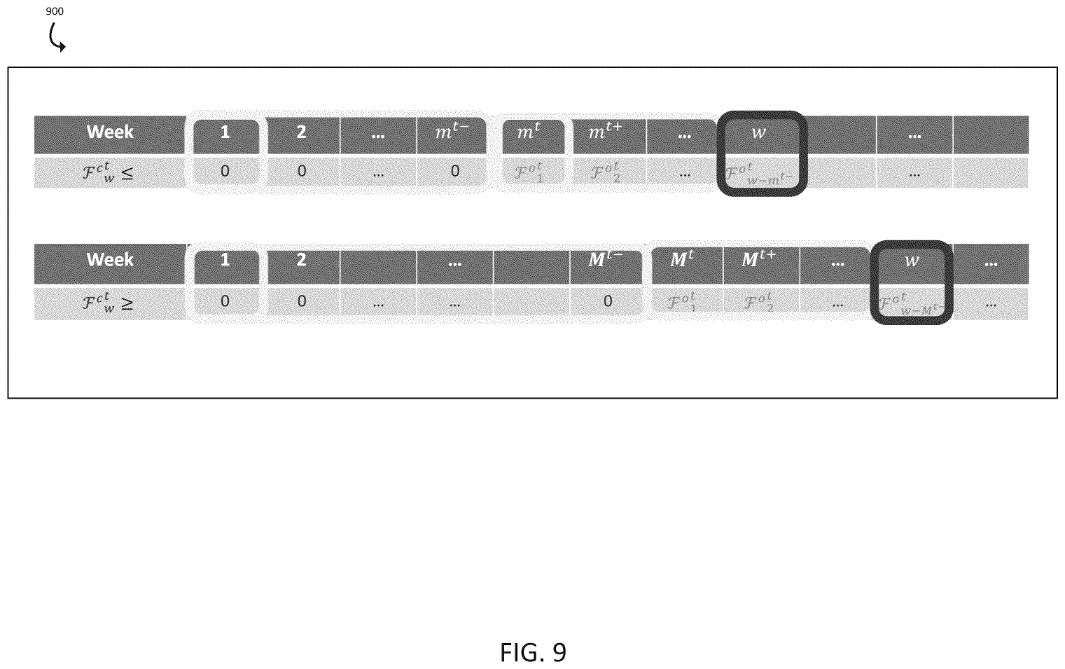

FIG. 9 depicts a proof 900 of opening and closing total inequalities, where The cumulated number of closings up to w≤the cumulated number of openings up to w−m^{t-}; the cumulated number of closings up to w≥the cumulated number of openings up to w−M^{t-}; and [symbol] _{w-M}_{^{t−}}^{o}^{^{t}}≤ [symbol] _{w}^{c}^{^{t}}≤ [symbol] _{w-m}_{^{t−}}^{o}^{^{t}}, e.g., [symbol] _{w+m}_{^{t−}}^{c}^{^{t}}≤ [symbol] _{w}^{o}^{^{t}}≤ [symbol] _{w+M}_{^{t−}}^{c}^{^{t}}.

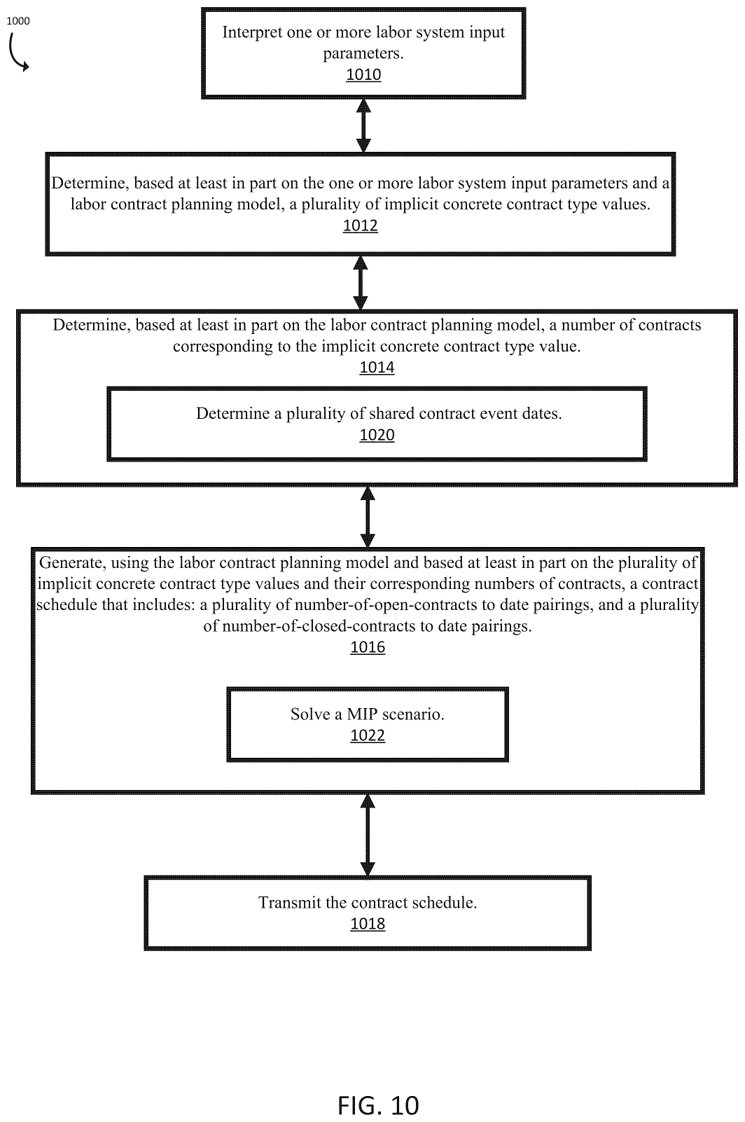

Shown in FIG. 10 is a method 1000 for workforce capacity planning, in accordance with embodiments of the current disclosure. The method 1000 may be performed by the apparatus 200 (FIG. 2) and/or any other computing device disclosed herein. The method 1000 includes interpreting one or more labor system input parameters 1010. The method 1000 further includes determining based at least in part on the one or more labor system input parameters and a labor contract planning model, a plurality of implicit concrete contract type values 1012. The method 1000 further includes for each of the plurality of implicit concrete contract type values, determining, based at least in part on the labor contract planning model, a number of contracts corresponding to the implicit concrete contract type value 1014. The method further includes generating, using the labor contract planning model and based at least in part on the plurality of implicit concrete contract type values and their corresponding numbers of contracts, a contract schedule that includes: a plurality of number-of-open-contracts to date pairings, and a plurality of number-of-closed-contracts to date pairings 1016. The method 1000 further includes transmitting the contract schedule 1018.

In embodiments, determining the plurality of implicit concrete contract type values 1014 may include determining a plurality of shared contract event dates 1020. Each of the plurality of implicit concrete contract type values may correspond to one of the plurality of shared contract event dates. In embodiments, the plurality of shared contract event dates include a shared opening date, and a shared closing date.

In embodiments, generating the contract schedule 1016 includes solving a MIP scenario 1022.

One or more certain further aspects of the example systems, apparatuses, and methods are described following, any one or more of which may be incorporated in certain embodiments.

An example method for workforce capacity planning includes: interpreting, via a labor parameter circuit, one or more labor system input parameters; and determining, via a contract type identifier circuit and based at least in part on the one or more labor system input parameters and a labor contract planning model, a plurality of implicit concrete contract type values. The method further includes for each of the plurality of implicit concrete contract type values, determining, via the contract type identifier circuit and based at least in part on the labor contract planning model, a number of contracts corresponding to the implicit concrete contract type value; generating, via a contract scheduling circuit using the labor contract planning model and based at least in part on the plurality of implicit concrete contract type values and their corresponding numbers of contracts, a contract schedule that includes: a plurality of number-of-open-contracts to date pairings, and a plurality of number-of-closed-contracts to date pairings; and transmitting, via a schedule provisioning circuit, the contract schedule.

In certain aspects, determining the plurality of implicit concrete contract type values includes determining a plurality of shared contract event dates. Each of the plurality of implicit concrete contract type values corresponds to one of the plurality of shared contract event dates. In certain aspects, the plurality of shared contract event dates includes: a shared opening date; and a shared closing date. In certain aspects, at least one of the plurality of implicit concrete contract type values corresponds to at least one of: a vendor service agreement; a vendor delivery of goods agreement; or an employment agreement. In certain aspects, the one or more labor system input parameters include at least one of: a demand value; a supply value; a minimum fire value; a maximum fire value; a Paid Time Off (PTO) policy; a target full-time to part-time ratio; or a baseline contract schedule. In certain aspects, the one or more labor system input parameters include at least the PTO policy, and the PTO policy includes at least one of: a PTO accrual formula; or a PTO release formula. In certain aspects, the contract schedule is for period of time greater-than-or-equal to one year. In certain aspects, the labor contract planning model includes a mixed-integer programming (MIP) scenario; and generating the contract schedule includes: solving the MIP scenario. In certain aspects, the MIP scenario has a size of: θ(T·W) variables; (T·W) constraints; and θ(T·W) non-zeros.

Embodiments of the current disclosure further provide for a non-transitory computer-readable medium that stores instructions for workforce capacity planning. The stored instructions, when executed by at least one processor, cause the at least one processor to: interpret, via a labor parameter circuit, one or more labor system input parameters; and determine, via a contract type identifier circuit and based at least in part on the one or more labor system input parameters and a labor contract planning model, a plurality of implicit concrete contract type values. The stored instructions further cause the at least one processor to: for each of the plurality of implicit concrete contract type values, determine, based at least in part on the labor contract planning model, a number of contracts corresponding to the implicit concrete contract type value; generate, using the labor contract planning model and based at least in part on the plurality of implicit concrete contract type values and their corresponding numbers of contracts, a contract schedule that includes: a plurality of number-of-open-contracts to date pairings, and a plurality of number-of-closed-contracts to date pairings; and transmit the contract schedule.

In certain aspects, the stored instructions further cause the at least one processor to determine a plurality of shared contract event dates. Each of the plurality of implicit concrete contract type values corresponds to one of the plurality of shared contract event dates. In certain aspects, the plurality of shared contract event dates includes: a shared opening date; and a shared closing date. In certain aspects, the one or more labor system input parameters include a PTO policy, and the PTO policy includes at least one of: a PTO accrual formula; or a PTO release formula. In certain aspects, the stored instructions further adapt the at least one processor to solve a mixed-integer programming (MIP) scenario, that forms part of the labor contract planning model, to generate the contract schedule. In certain aspects, the MIP scenario includes a full time to part time ratio constraint. In certain aspects, the MIP scenario includes a paid-time-off (PTO) constraint; and the stored instructions further adapt the at least one processor to: generate a PTO release plan; and transmit the PTO release plan. In certain aspects, the PTO constraint models accrued PTO; and released PTO.

Embodiments of the current disclosure also provide for an apparatus for workforce capacity planning. The apparatus includes: a labor parameter circuit; a contract type identifier circuit; a contract scheduling circuit; and a schedule provisioning circuit. The labor parameter circuit is structured to interpret one or more labor system input parameters. The contract type identifier circuit structured to: determine, based at least in part on the one or more labor system input parameters and a labor contract planning model, a plurality of implicit concrete contract type values; and for each of the plurality of implicit concrete contract type values, determine, based at least in part on the labor contract planning model, a number of contracts corresponding to the implicit concrete contract type value. The contract scheduling circuit is structured to generate, using the labor contract planning model and based at least in part on the plurality of implicit concrete contract type values and their corresponding numbers of contracts, a contract schedule that includes: a plurality of number-of-open-contracts to date pairings, and a plurality of number-of-closed-contracts to date pairings. The schedule provisioning circuit is structured to transmit the contract schedule.

In certain aspects, the labor contract planning model includes a mixed-integer programming (MIP) scenario; and generating the contract schedule includes solving the MIP scenario. In certain aspects, the plurality of implicit concrete contract type values includes: an open-implicit concrete contract type value; and a closed-implicit concrete contract type value.

Non-limiting use cases for long-term/strategic workforce capacity planning include: corporate operating models; process improvement validation; human resources (HR) strategy; tactical contract and holiday planning recommendations; bottom-up standards-driven labor demand; budget hours and wages, etc.

Further, embodiments of the current disclosure provide for the managing of certain aspects, e.g., attrition, ramp-up, overtime, efficiency, etc., rather than considering such aspects as simple a priori fixed percentages. Embodiments of the labor contract planning model 220 may be combined with complementary models and/or algorithms, such as those for assigning specific contracts, and/or for implementing and/or managing specific PTO policies which, in turn, may improve employee overall satisfaction. Embodiments of the labor contract planning model 220 may also be combined with tools that leverage historical HR and/or workforce management (WFM) data to determine accurate attrition and/or efficiency rates over time and/or to refine a workforce capacity plan. Thus, as will be appreciated, certain embodiments of the current disclosure may provide for the incorporation of features that are not handled by traditional workforce planning systems, such as ramp-up, efficiency, PTO policies, etc.

As disclosed herein, embodiments of the labor contract planning model 220 are structured so that they greatly improve the processing speeds/time to solve workforce capacity MIP problems over traditional approaches. For example, may traditional approaches enumerate all possible contracts and formulate a set covering the problem, e.g., past approaches formulate a MIP problem that: focuses on contract selection variables and weekly hours per contract variables, and the linking of constraints between variables and weekly coverage constraints. Such approaches, however, result in a MIP having a size of: θ(T·W²) in term of variables; O(T·W²) in term of constraints; and O(T·W²) in term of non-zeros, where T(˜10) is the number of contracts and W(˜100) the number of optimized weeks. In contrast, embodiments of the current disclosure structure a MIP problem to use implicit concrete contracts, as opposed to enumerating all possible contracts. In other words, certain embodiments of the current disclosure are structured to consider the opening and/or closing variables and their total inequalities, e.g., necessary and sufficient conditions, where the concrete contracts may be obtainable by chronological opening/closing assignments. As will be appreciated, this approach results in certain embodiments of the current disclosure having a size of: θ(T·W) in term of variables; θ(T·W) in term of constraints; and θ(T·W) in term of non-zeros, where the size of the MIP divided by W(˜100) in terms of variables, constraints and non-zeros. This reduction in the size, as compared to the traditional approach, provides for longer contract schedule periods to be generated in a shorter period of time, as compared to traditional approaches which, in turn, improves the long-term planning capability of a corporation. Such improved long-term planning capability may provide for a business to mitigate over/under hiring, over/under purchasing of materials, and/or to otherwise smooth out cyclical decision processes.

Additionally, embodiments of the current disclosure provide for a labor contract planning model 220 that supports: configurable ramp-up period/proficiency level sets instead of a fixed two weeks interval; configurable ranges of regular hours instead of fixed amounts; configurable overtime thresholds instead of unbounded amounts; more accurately configured full time/par time ratios; and/or more realistic release plans of personal time off avoiding undesirable carry-overs from one calendar year to another and offering a more accurate distribution.

The methods and systems described herein may be deployed in part or in whole through a machine having a computer, computing device, processor, circuit, and/or server that executes computer readable instructions, program codes, instructions, and/or includes hardware configured to functionally execute one or more operations of the methods and systems disclosed herein. The terms computer, computing device, processor, circuit, and/or server, as utilized herein, should be understood broadly.

Any one or more of the terms computer, computing device, processor, circuit, and/or server include a computer of any type, capable to access instructions stored in communication thereto such as upon a non-transient computer readable medium, whereupon the computer performs operations of systems or methods described herein upon executing the instructions. In certain embodiments, such instructions themselves comprise a computer, computing device, processor, circuit, and/or server. Additionally or alternatively, a computer, computing device, processor, circuit, and/or server may be a separate hardware device, one or more computing resources distributed across hardware devices, and/or may include such aspects as logical circuits, embedded circuits, sensors, actuators, input and/or output devices, network and/or communication resources, memory resources of any type, processing resources of any type, and/or hardware devices configured to be responsive to determined conditions to functionally execute one or more operations of systems and methods herein.

Network and/or communication resources include, without limitation, local area network, wide area network, wireless, internet, or any other known communication resources and protocols. Example and non-limiting hardware, computers, computing devices, processors, circuits, and/or servers include, without limitation, a general-purpose computer, a server, an embedded computer, a mobile device, a virtual machine, and/or an emulated version of one or more of these. Example and non-limiting hardware, computers, computing devices, processors, circuits, and/or servers may be physical, logical, or virtual. A computer, computing device, processor, circuit, and/or server may be: a distributed resource included as an aspect of several devices; and/or included as an interoperable set of resources to perform described functions of the computer, computing device, processor, circuit, and/or server, such that the distributed resources function together to perform the operations of the computer, computing device, processor, circuit, and/or server. In certain embodiments, each computer, computing device, processor, circuit, and/or server may be on separate hardware, and/or one or more hardware devices may include aspects of more than one computer, computing device, processor, circuit, and/or server, for example as separately executable instructions stored on the hardware device, and/or as logically partitioned aspects of a set of executable instructions, with some aspects of the hardware device comprising a part of a first computer, computing device, processor, circuit, and/or server, and some aspects of the hardware device comprising a part of a second computer, computing device, processor, circuit, and/or server.

A computer, computing device, processor, circuit, and/or server may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer readable instructions on a server, client, firewall, gateway, hub, router, or other such computer and/or networking hardware. The computer readable instructions may be associated with a server that may include a file server, print server, domain server, internet server, intranet server and other variants such as secondary server, host server, distributed server and the like. The server may include one or more of memories, processors, computer readable transitory and/or non-transitory media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, and the like. Additionally, this coupling and/or connection may facilitate remote execution of instructions across the network. The networking of some or all of these devices may facilitate parallel processing of program code, instructions, and/or programs at one or more locations without deviating from the scope of the disclosure. In addition, all the devices attached to the server through an interface may include at least one storage medium capable of storing methods, program code, instructions, and/or programs. A central repository may provide program instructions to be executed on different devices. In this implementation, the remote repository may act as a storage medium for methods, program code, instructions, and/or programs.

The methods, program code, instructions, and/or programs may be associated with a client that may include a file client, print client, domain client, internet client, intranet client and other variants such as secondary client, host client, distributed client and the like. The client may include one or more of memories, processors, computer readable transitory and/or non-transitory media, storage media, ports (physical and virtual), communication devices, and interfaces capable of accessing other clients, servers, machines, and devices through a wired or a wireless medium, and the like. The methods, program code, instructions, and/or programs as described herein and elsewhere may be executed by the client. In addition, other devices utilized for execution of methods as described in this application may be considered as a part of the infrastructure associated with the client.

The client may provide an interface to other devices including, without limitation, servers, other clients, printers, database servers, print servers, file servers, communication servers, distributed servers, and the like. Additionally, this coupling and/or connection may facilitate remote execution of methods, program code, instructions, and/or programs across the network. The networking of some or all of these devices may facilitate parallel processing of methods, program code, instructions, and/or programs at one or more locations without deviating from the scope of the disclosure. In addition, all the devices attached to the client through an interface may include at least one storage medium capable of storing methods, program code, instructions, and/or programs. A central repository may provide program instructions to be executed on different devices. In this implementation, the remote repository may act as a storage medium for methods, program code, instructions, and/or programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules, and/or components as known in the art. The computing and/or non-computing device(s) associated with the network infrastructure may include, apart from other components, a storage medium such as flash memory, buffer, stack, RAM, ROM and the like. The methods, program code, instructions, and/or programs described herein and elsewhere may be executed by one or more of the network infrastructural elements.

The methods, program code, instructions, and/or programs described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like.

The methods, program code, instructions, and/or programs described herein and elsewhere may be implemented on or through mobile devices. The mobile devices may include navigation devices, cell phones, mobile phones, mobile personal digital assistants, laptops, palmtops, netbooks, pagers, electronic books readers, music players, and the like. These mobile devices may include, apart from other components, a storage medium such as a flash memory, buffer, RAM, ROM and one or more computing devices. The computing devices associated with mobile devices may be enabled to execute methods, program code, instructions, and/or programs stored thereon. Alternatively, the mobile devices may be configured to execute instructions in collaboration with other devices. The mobile devices may communicate with base stations interfaced with servers and configured to execute methods, program code, instructions, and/or programs. The mobile devices may communicate on a peer-to-peer network, mesh network, or other communications network. The methods, program code, instructions, and/or programs may be stored on the storage medium associated with the server and executed by a computing device embedded within the server. The base station may include a computing device and a storage medium. The storage device may store methods, program code, instructions, and/or programs executed by the computing devices associated with the base station.

The methods, program code, instructions, and/or programs may be stored and/or accessed on machine readable transitory and/or non-transitory media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

Certain operations described herein include interpreting, receiving, and/or determining one or more values, parameters, inputs, data, or other information. Operations including interpreting, receiving, and/or determining any value parameter, input, data, and/or other information include, without limitation: receiving data via a user input; receiving data over a network of any type; reading a data value from a memory location in communication with the receiving device; utilizing a default value as a received data value; estimating, calculating, or deriving a data value based on other information available to the receiving device; and/or updating any of these in response to a later received data value. In certain embodiments, a data value may be received by a first operation, and later updated by a second operation, as part of the receiving a data value. For example, when communications are down, intermittent, or interrupted, a first operation to interpret, receive, and/or determine a data value may be performed, and when communications are restored an updated operation to interpret, receive, and/or determine the data value may be performed.

Certain logical groupings of operations herein, for example methods or procedures of the current disclosure, are provided to illustrate aspects of the present disclosure. Operations described herein are schematically described and/or depicted, and operations may be combined, divided, re-ordered, added, or removed in a manner consistent with the disclosure herein. It is understood that the context of an operational description may require an ordering for one or more operations, and/or an order for one or more operations may be explicitly disclosed, but the order of operations should be understood broadly, where any equivalent grouping of operations to provide an equivalent outcome of operations is specifically contemplated herein. For example, if a value is used in one operational step, the determining of the value may be required before that operational step in certain contexts (e.g., where the time delay of data for an operation to achieve a certain effect is important), but may not be required before that operation step in other contexts (e.g., where usage of the value from a previous execution cycle of the operations would be sufficient for those purposes). Accordingly, in certain embodiments an order of operations and grouping of operations as described is explicitly contemplated herein, and in certain embodiments re-ordering, subdivision, and/or different grouping of operations is explicitly contemplated herein.

The methods and systems described herein may transform physical and/or or intangible items from one state to another. The methods and systems described herein may also transform data representing physical and/or intangible items from one state to another.

The elements described and depicted herein, including in flow charts, block diagrams, and/or operational descriptions, depict and/or describe specific example arrangements of elements for purposes of illustration. However, the depicted and/or described elements, the functions thereof, and/or arrangements of these, may be implemented on machines, such as through computer executable transitory and/or non-transitory media having a processor capable of executing program instructions stored thereon, and/or as logical circuits or hardware arrangements. Example arrangements of programming instructions include at least: monolithic structure of instructions; standalone modules of instructions for elements or portions thereof; and/or as modules of instructions that employ external routines, code, services, and so forth; and/or any combination of these, and all such implementations are contemplated to be within the scope of embodiments of the present disclosure Examples of such machines include, without limitation, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements described and/or depicted herein, and/or any other logical components, may be implemented on a machine capable of executing program instructions. Thus, while the foregoing flow charts, block diagrams, and/or operational descriptions set forth functional aspects of the disclosed systems, any arrangement of program instructions implementing these functional aspects are contemplated herein. Similarly, it will be appreciated that the various steps identified and described above may be varied, and that the order of steps may be adapted to particular applications of the techniques disclosed herein. Additionally, any steps or operations may be divided and/or combined in any manner providing similar functionality to the described operations. All such variations and modifications are contemplated in the present disclosure. The methods and/or processes described above, and steps thereof, may be implemented in hardware, program code, instructions, and/or programs or any combination of hardware and methods, program code, instructions, and/or programs suitable for a particular application. Example hardware includes a dedicated computing device or specific computing device, a particular aspect or component of a specific computing device, and/or an arrangement of hardware components and/or logical circuits to perform one or more of the operations of a method and/or system. The processes may be implemented in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and computer readable instructions, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or computer-readable instructions described above. All such permutations and combinations are contemplated in embodiments of the present disclosure.

While the disclosure has been disclosed in connection with the preferred embodiments shown and described in detail, various modifications and improvements thereon will become readily apparent to those skilled in the art. Accordingly, the spirit and scope of the present disclosure is not to be limited by the foregoing examples but is to be understood in the broadest sense allowable by law.

What is claimed is:

1. A method comprising:
interpreting, via a labor parameter circuit, one or more labor system input parameters;
determining, via a contract type identifier circuit and based at least in part on the one or more labor system input parameters and a labor contract planning model, a plurality of implicit concrete contract type values;
for each of the plurality of implicit concrete contract type values, determining, via the contract type identifier circuit and based at least in part on the labor contract planning model, a number of contracts corresponding to the implicit concrete contract type value;
generating, via a contract scheduling circuit using the labor contract planning model and based at least in part on the plurality of implicit concrete contract type values and their corresponding numbers of contracts, a contract schedule that includes: a plurality of number-of-open-contracts to date pairings, and a plurality of number-of-closed-contracts to date pairings; and
transmitting, via a schedule provisioning circuit, the contract schedule.

2. The method of claim 1, wherein determining the plurality of implicit concrete contract type values comprises:
determining a plurality of shared contract event dates;
wherein each of the plurality of implicit concrete contract type values corresponds to one of the plurality of shared contract event dates.

3. The method of claim 2, wherein the plurality of shared contract event dates comprises:
a shared opening date; and
a shared closing date.

4. The method of claim 2, wherein at least one of the plurality of implicit concrete contract type values corresponds to at least one of:
a vendor service agreement;
a vendor delivery of goods agreement; or
an employment agreement.

5. The method of claim 1, wherein the one or more labor system input parameters comprise at least one of:
a demand value;
a supply value;
a minimum fire value;
a maximum fire value;
a Paid Time Off (PTO) policy;
a target full-time to part-time ratio; or
a baseline contract schedule.

6. The method of claim 5, wherein the one or more labor system input parameters comprises at least the PTO policy, and the PTO policy comprises at least one of:
a PTO accrual formula; or
a PTO release formula.

7. The method of claim 1, wherein the contract schedule is for period of time greater-than-or-equal to one year.

8. The method of claim 1, wherein:
the labor contract planning model comprises a mixed-integer programming (MIP) scenario; and
generating the contract schedule comprises:
solving the MIP scenario.

9. The method of claim 8, wherein the MIP scenario has a size of:
θ(T·W) variables;
θ(T·W) constraints; and
θ(T·W) non-zeros.

10. A non-transitory computer-readable medium storing instructions that, when executed by at least one processor, cause the at least one processor to:
interpret, via a labor parameter circuit, one or more labor system input parameters;
determine, via a contract type identifier circuit and based at least in part on the one or more labor system input parameters and a labor contract planning model, a plurality of implicit concrete contract type values;
for each of the plurality of implicit concrete contract type values, determine, based at least in part on the labor contract planning model, a number of contracts corresponding to the implicit concrete contract type value;
generate, using the labor contract planning model and based at least in part on the plurality of implicit concrete contract type values and their corresponding numbers of contracts, a contract schedule that includes: a plurality of number-of-open-contracts to date pairings, and a plurality of number-of-closed-contracts to date pairings; and
transmit the contract schedule.

11. The non-transitory computer-readable medium of claim 10, wherein the stored instructions further cause the at least one processor to:
determine a plurality of shared contract event dates;
wherein each of the plurality of implicit concrete contract type values corresponds to one of the plurality of shared contract event dates.

12. The non-transitory computer-readable medium of claim 11, wherein the plurality of shared contract event dates comprises:
a shared opening date; and
a shared closing date.

13. The non-transitory computer-readable medium of claim 12, wherein the one or more labor system input parameters comprise a PTO policy, and the PTO policy comprises at least one of:
a PTO accrual formula; or
a PTO release formula.

14. The non-transitory computer-readable medium of claim 10, wherein the stored instructions further adapt the at least one processor to:
solve a mixed-integer programming (MIP) scenario, that forms part of the labor contract planning model, to generate the contract schedule.

15. The non-transitory computer-readable medium of claim 14, wherein the MIP scenario comprises a full time to part time ratio constraint.

16. The non-transitory computer-readable medium of claim 14, wherein:
the MIP scenario comprises a paid-time-off (PTO) constraint; and
the stored instructions further adapt the at least one processor to:
generate a PTO release plan; and
transmit the PTO release plan.

17. The non-transitory computer-readable medium of claim 16, wherein the PTO constraint models:
accrued PTO; and
released PTO.

18. An apparatus comprising:
a labor parameter circuit structured to interpret one or more labor system input parameters;
a contract type identifier circuit structured to:
determine, based at least in part on the one or more labor system input parameters and a labor contract planning model, a plurality of implicit concrete contract type values; and
for each of the plurality of implicit concrete contract type values, determine, based at least in part on the labor contract planning model, a number of contracts corresponding to the implicit concrete contract type value;
a contract scheduling circuit structured to generate, using the labor contract planning model and based at least in part on the plurality of implicit concrete contract type values and their corresponding numbers of contracts, a contract schedule that includes: a plurality of number-of-open-contracts to date pairings, and a plurality of number-of-closed-contracts to date pairings; and
a schedule provisioning circuit structured to transmit the contract schedule.

19. The apparatus of claim 18, wherein:
the labor contract planning model comprises a mixed-integer programming (MIP) scenario; and
generating the contract schedule comprises:
solving the MIP scenario.

20. The apparatus of claim 18, wherein the plurality of implicit concrete contract type values comprises:
an open-implicit concrete contract type value; and
a closed-implicit concrete contract type value.
